(19) United States
(12) Patent Application Publication
(10) Pub. No.: US 2011/0032939 A1
(43) Pub. Date: Feb. 10, 2011

(54) NETWORK SYSTEM, PACKET FORWARDING APPARATUS, AND METHOD OF FORWARDING PACKETS

(75) Inventors: Shinji NOZAKI, Kawasaki (JP); Masaya ARAI, Atsugi (JP)

Correspondence Address: MATTINGLY & MALUR, P.C., 1800 DIAGONAL ROAD, SUITE 370, ALEXANDRIA, VA, 22314, US

(73) Assignee: ALAXALA NETWORKS CORPORATION, Kanagawa (JP)

(21) Appl. No.: 12/835,261

(22) Filed: Jul. 13, 2010

(30) Foreign Application Priority Data
Aug. 10, 2009 (JP) 2009-185580

(51) Int. Cl. H04L 12/56; H04L 29/06

(52) U.S. Cl. 370/392; 726/3; 726/4

(57) ABSTRACT

A network system includes: a first network; an authentication server; a second network; a network; and a packet forwarding apparatus, wherein the packet forwarding apparatus includes: a forwarding route table storage storing a first forwarding route table containing packet routing information to the second network, and a second forwarding route table containing packet routing information to the second network and the third network; and a forwarding route table selector that, prior to determination of successful authentication for the terminal apparatus, selects the first forwarding route table as a search forwarding route table, and that upon receipt of determination of successful authentication for the terminal apparatus, selects the second forwarding route table as the search forwarding route table.

### CROSS-REFERENCE TO RELATED APPLICATIONS

The present application claims priority to Japanese Patent Application No. 2009-185580 filed on Aug. 10, 2009, the disclosure of which is hereby incorporated by reference in its entirety.

### BACKGROUND OF THE INVENTION

1. Field of the Invention

The present invention relates to technology for forwarding of packets sent by a terminal apparatus.

2. Description of the Related Art

In network systems requiring that authentication or quarantine (hereinafter termed simply “authentication”) be carried out before a terminal (terminal apparatus) can join a network, from a security standpoint there is a need to ensure independence between the network that performs authentication (hereinafter termed simply the “authentication network”) and the network that is accessed subsequent to authentication (which is a different network from the network to which the terminal belongs and from the authentication network (hereinafter termed simply the “enterprise network”)) so that communication does not take place between the respective networks.

Accordingly, there have been proposed systems whereby different VLANs (Virtual Local Area Network) are assigned to the respective networks, and after successful authentication, the VLAN in which the terminal has membership moves, and communication is enabled at the destination VLAN (dynamic VLAN systems). There have also been proposed systems whereby, instead of the VLAN moving before and after authentication, prior to authentication only communication for the purpose of authentication (communication in Layer 2) is enabled, with all other communication being disabled (static VLAN systems). However, a problem with dynamic VLAN systems is that different IP addresses are assigned to the same terminal before and after authentication, so IP address utilization efficiency is low. A problem with static VLAN systems is that communication in Layer 3 is not possible prior to authentication.

For this reason there has also been proposed a method whereby the respective networks are configured as VPNs (Virtual Private Network), each VPN being provided with a DHCP (Dynamic Host Configuration Protocol) server; after successful authentication, the VLAN in which the terminal has membership moves, but information on the DHCP servers is synchronized so that the terminal continues to be assigned the same IP address subsequent to authentication.

One problem with the above technique of isolating the authentication network and the enterprise network through VPNs is that subsequent to authentication, the terminal can no longer access the authentication network. This creates the problem that the server belonging to the authentication network (the authentication server) cannot be used, for example, to carry out periodic quarantines (e.g. that the virus definition file is the most recent or that the operating system is the latest version) for the authenticated terminal. This problem is not limited to terminals, and is encountered with servers belonging to the enterprise network (enterprise servers) as well. Specifically, the problem is that because the authentication network and the enterprise network are isolated through VPNs, an enterprise server cannot access the authentication network, so authentication or quarantine using the authentication server cannot be carried out for the enterprise server. Additionally, it is necessary in such systems to provide multiple DHCP servers, and for each of these DHCP servers to be provided with the special function of synchronizing with one another, which leads to higher costs associated with building the network system.

The above problem is not limited to IP addresses, and arises whenever packets are forwarded using any Layer 3 addresses such as IPX (Internetwork Packet eXchange) addresses.

### SUMMARY

There are requirements for improving the utilization efficiency of Layer 3 addresses in a network system, and for making the authentication network accessible from a terminal apparatus subsequent to authentication, and from the enterprise network.

Some aspects of the present invention in order to address the above issue at least in part are described below.

According to the first aspect of the present invention, a network system is provided. The network system includes: a first network;

an authentication server configured to execute an authentication process when a terminal apparatus joins the first network;

a second network to which the authentication server is connected;

a third network to which the terminal apparatus and the authentication server are not connected; and

a packet forwarding apparatus being connected to the first network, the second network, and the third network, and forwarding packets,

wherein the packet forwarding apparatus includes:

a forwarding route table storage storing a first forwarding route table that contains packet routing information to a prescribed device connected to the second network, and a second forwarding route table that contains packet routing information to a prescribed device connected to the second network and packet routing information to a prescribed device connected to the third network; and

a forwarding route table selector that, prior to determination of successful authentication for the terminal apparatus by the authentication server, selects the first forwarding route table as a search forwarding route table that is used for searching for a packet routing information applied to packets from the terminal apparatus, and that upon receipt of determination of successful authentication for the terminal apparatus by the authentication server, selects the second forwarding route table as the search forwarding route table.

In the network system according to the first aspect the invention, prior to determination of successful authentication for a terminal by the authentication server, a first forwarding route table that includes packet routing information to a prescribed device connected to the second network is employed for packets sent from the terminal, and thus packet forwarding of packets from the terminal to the second network (authentication server) is allowed, while forwarding to the third network is prevented. After determination of successful authentication, a second forwarding routing information group that includes packet routing information to prescribed devices connected to the second and third networks is employed for packets from the terminal, and thus forwarding of packets from the terminal to the second and third networks is allowed. Consequently, access to the second network to which the authentication server connected is possible from the authenticated terminal and from the third network. Additionally, because there is no need to assign multiple addresses (Layer 3 addresses) to the terminal, address utilization efficiency may be improved. In the first aspect, the term “authentication” is used in a broad sense to include both authentication and quarantine.

In one preferable application of the network system according to the first aspect of the invention, further comprising:

a search forwarding route table selection table associating sender identifiers that identify the packet sender with the search forwarding route tables; and

a table updater updating the search forwarding route table selection table;

wherein the forwarding route table selector selects the forwarding route table for a received packet according to the search forwarding route table selection table;

the search forwarding route table selection table preliminary associates the first forwarding route table with the sender identifier of the terminal apparatus prior to determination of successful authentication of the terminal apparatus by the authentication server; and

upon receipt of determination of successful authentication of the terminal apparatus by the authentication server, the table updater updates the search forwarding route table selection table so as to associate the second forwarding route table with the sender identifier of the terminal apparatus.

In the network system of this application, through lookup the search forwarding route table selection table, packet forwarding routing of packets from the terminal prior to successful authentication can be determined from the first forwarding route table, and packet forwarding routing of packets from the terminal subsequent to successful authentication can be determined from the second forwarding route table.

In another preferable application of the network system according to the first aspect of the invention, the network system includes a plurality of the third networks;

the forwarding route table storage stores a plurality of the second forwarding route tables that include packet routing information to prescribed devices connected to mutually different third networks and packet routing information to a prescribed device connected to the second network;

the authentication server notifies the forwarding route table selector of an outcome of the authentication process and of information relating to at least one authorized network that authorized for connection and included among the plurality of the third networks; and

the forwarding route table selector, prior to determination of successful authentication of the terminal apparatus by the authentication server, selects the first forwarding route table as the search forwarding route table applied to packets from the terminal apparatus, and upon receipt of determination of successful authentication of the terminal apparatus by the authentication server, selects the second forwarding route table that contains packet routing information to a prescribed device connected to the at least one authorized network from among the plurality of second forwarding route tables, as the search forwarding route table applied to packets from the terminal apparatus.

In the network system of this application, packets sent from the terminal subsequent to authentication are allowed to be forwarded to networks to which connections are permitted, and prevented from being forwarded to networks to which connections are not permitted.

In another preferable application of the network system according to the first aspect of the invention, the packets are IP packets; and the sender identifier is at least one of the MAC address and the IP address.

In the network system of this application, IP addresses which are used for carrying out Layer 3 communications or MAC addresses which are used for carrying out Layer 2 communications can be used as sender identifiers, making it easier to build a network system, as compared to a configuration that uses separate sender identifiers that are different from these identifiers.

In another preferable application of the network system according to the first aspect of the invention, when an authentication for the terminal apparatus connected to first network is revoked by the authentication server, the forwarding route table selector switches back from the second forwarding route table to the first forwarding route table as the search forwarding route table applied to packets from the terminal apparatus.

In the network system of this application, during forwarding of packets from a terminal whose authentication was revoked, forwarding routing can be determined from the first forwarding route table, thereby preventing packets from being forwarded from the revoked authentication terminal to the third network.

In another preferable application of the network system according to the first aspect of the invention, further comprising:

a forwarding route selector selecting a packet forwarding route; and

a forwarding route table updater updating forwarding route tables stored in the forwarding route table storage; wherein

in addition to the first forwarding route table and the second forwarding route table, the forwarding route table storage stores a third forwarding route table that includes packet routing information to a prescribed device connected to the first network;

the forwarding route table selector selects the second forwarding route table as the search forwarding route table for forwarding packets from each third network to the first network and the second network, and selects the third forwarding route table as the search forwarding route table for forwarding packets from the second network to the first network; and

the forwarding route table updater, during packet forwarding from the authentication server to the terminal apparatus in the authentication process, adds to the third forwarding route table terminal apparatus routing information representing packet routing information to the terminal apparatus that was selected by the forwarding route selector, and upon receipt of determination of successful authentication of the terminal apparatus by the authentication server, acquires the terminal apparatus routing information from the third forwarding route table and copies the terminal apparatus routing information to the second forwarding route table that is included among the plurality of second forwarding route tables and that contains packet routing information to a prescribed device connected to the at least one authorized network.

In the network system of this application, it is not necessary for forwarding routing destined for the first network (forwarding routing destined for a prescribed device in the first network) to be established in advance in the second forwarding route table. Consequently, it is possible to prevent communication from a device connected to the third network to an unspecified terminal connected to the first network, so that security may be enhanced.

In another preferable application of the network system according to the first aspect of the invention, when the authentication of the terminal apparatus connected to the first network is revoked by the authentication server, the forwarding route table updater deletes the terminal apparatus routing information from the second forwarding routing table.

In the network system of this application, during forwarding of packets from a terminal whose authentication was revoked, forwarding routing can be determined from the first forwarding route table, thereby preventing packets from being forwarded from the revoked authentication terminal to the third network.

In another preferable application of the network system according to the first aspect of the invention, further comprising:

a forwarding route selector selecting packet forwarding routes;

wherein the first forwarding route table and the second forwarding route table are constituted as an integrated forwarding route table;

the search forwarding route table selection table associating the sender identifier with the outcome of the authentication process and with a search forwarding route table identifier indicating the search forwarding route table;

the integrated forwarding route table associating routing information contained in the first forwarding route table and in the second forwarding route table with the outcome of the authentication process and with the search forwarding route table identifier;

the search forwarding route table selection table, preliminary associates the sender identifier of the terminal apparatus with information indicating that the authentication process has not successfully taken place, and with an identifier representing the first forwarding route table as the search forwarding route table identifier prior to determination of successful authentication of the terminal apparatus by the authentication server;

the authentication server notifies the table updater at least the outcome of the authentication process;

the table updater, upon being notified of successful authentication of the terminal apparatus by the authentication server, updates the search forwarding route table selection table so as to associate the sender identifier of the terminal apparatus with information indicating that the authentication process was successful and with an identifier representing the second forwarding table as the search forwarding route table identifier;

for a received packet, the forwarding route table selector looks up the search forwarding route table selection table according to the sender identifier of the packet, and acquires the outcome of the authentication process and the search forwarding route table identifier; and

the forwarding route selector looks up the integrated forwarding route table, and selects a forwarding route for the packet according to the outcome of the authentication process and the search forwarding route table identifier acquired by the forwarding route table selector.

In the network system of this application, duplicate entries indicating forwarding routing to a given device can be minimized, as compared with an arrangement in which the first forwarding route table and the second forwarding route table are stored as respectively different forwarding route tables, and the capacity required in the forwarding route table storage may be reduced.

In another preferable application of the network system according to the first aspect of the invention, the network system includes a plurality of the third networks;

the forwarding route table storage stores a plurality of the second forwarding route tables that include packet routing information to prescribed devices connected to mutually different third networks, and packet routing information to a prescribed device connected to the second network;

the authentication server notifies the table updater of the outcome of the authentication process and of an information relating at least one authorized network authorized for connection and included among the plurality of the third networks; and

upon being notified of successful authentication of the terminal apparatus and the information relating to the at least one authorized network by the authentication server, the table updater updates the search forwarding route table selection table so as to associate the sender identifier of the terminal apparatus with information indicating that the authentication process was successful, and, as the search forwarding route identifier, with the identifier identifying the second forwarding route table that contains packet routing information to a prescribed device connected to the at least one authorized network and that is selected from among the plurality of second forwarding route tables.

In the network system of this application, it is not necessary for forwarding routing destined for the first network (forwarding routing destined for a prescribed device in the first network) to be established in advance in the integrated forwarding route table. Consequently, it is possible to prevent communication from a device connected to the third network to an unspecified terminal connected to the first network, so that security may be enhanced.

In another preferable application of the network system according to the first aspect of the invention, further comprising:

a combination table associating combinations of the second forwarding route tables that contain packet routing information to prescribed devices connected to the at least one authorized network with combination identifiers that identify the combinations,

wherein the search forwarding route table selection table and the integrated forwarding route table use the combination identifiers as the search forwarding route table identifiers for the second forwarding route tables; and upon being notified of successful authentication of the terminal apparatus and the information relating to the at least one authorized network by the authentication server, the table updater acquires from the combination table an authorized combination identifier that is a combination identifier of a combination of the second forwarding route tables containing packet routing information to prescribed devices connected to the at least one authorized network, and updates the search forwarding route table selection table so as to associate the sender identifier of the terminal apparatus with information indicating that the authentication process was successful, and with the authorized combination identifier.

In the network system of this application, in the event that a terminal is granted connection permissions to multiple networks in the authentication process, search forwarding route tables for use by packets destined for prescribed devices connected to permitted networks can be easily specified (described) in the integrated forwarding route table, and the capacity required in the forwarding route table storage may be reduced.

According to the second aspect of the present invention, a packet forwarding apparatus is provided. The packet forwarding apparatus configured to forward packets and to be connected to a first network, a second network to which an authentication server executing an authentication process when a terminal apparatus joins the first network is connected, and a third network to which the terminal apparatus and the authentication server are not connected, comprising:

a forwarding route table storage storing a first forwarding route table that contains packet routing information to a prescribed device connected to the second network, and a second forwarding route table that contains packet routing information to a prescribed device connected to the second network and packet routing information to a prescribed device connected to the third network; and

a forwarding route table selector that, prior to determination of successful authentication for the terminal apparatus by the authentication server, selects the first forwarding route table as a search forwarding route table used for searching for a packet routing information applied to packets from the terminal apparatus, and that upon receipt of determination of successful authentication for the terminal apparatus by the authentication server, selects the second forwarding route table as the search forwarding route table.

In the packet forwarding apparatus of this application, prior to determination of successful authentication for a terminal by the authentication server, a first forwarding route table that includes packet routing information to a prescribed device connected to the second network is employed for packets sent from the terminal, and thus packet forwarding of packets from the terminal to the second network (authentication server) is allowed, while forwarding to the third network is prevented. After determination of successful authentication, a second forwarding routing information group that includes packet routing information to prescribed devices connected to the second and third networks is employed for packets from the terminal, and thus forwarding of packets from the terminal to the second and third networks is allowed. Consequently, access to the second network to which the authentication server connected is possible from the authenticated terminal and from the third network. Additionally, because there is no need to assign multiple addresses (Layer 3 addresses) to the terminal, address utilization efficiency may be improved. In the first aspect, the term “authentication” is used in a broad sense to include both authentication and quarantine.

According to the third aspect of the present invention, a method of forwarding packets in a packet forwarding apparatus, the packet forwarding apparatus configured to forward packets and to be connected to a first network, a second network to which an authentication server executing an authentication process when a terminal apparatus joins the first network is connected, and a third network to which the terminal apparatus and the authentication server are not connected, is provided. The method includes: (a) storing in the packet forwarding apparatus a first forwarding route table that contains packet routing information to a prescribed device connected to the second network, and a second forwarding route table that contains packet routing information to a prescribed device connected to the second network and packet routing information to a prescribed device connected to the third network; and

(b) prior to determination of successful authentication for the terminal apparatus by the authentication server, selecting the first forwarding route table as a search forwarding route table that is used for searching for a packet routing information applied to packets from the terminal apparatus, and upon receipt of determination of successful authentication for the terminal apparatus by the authentication server, selecting the second forwarding route table as the search forwarding route table.

In the method of forwarding packets of this application, prior to determination of successful authentication for a terminal by the authentication server, a first forwarding route table that includes packet routing information to a prescribed device connected to the second network is employed for packets sent from the terminal, and thus packet forwarding of packets from the terminal to the second network (authentication server) is allowed, while forwarding to the third network is prevented. After determination of successful authentication, a second forwarding routing information group that includes packet routing information to prescribed devices connected to the second and third networks is employed for packets from the terminal, and thus forwarding of packets from the terminal to the second and third networks is allowed. Consequently, access to the second network to which the authentication server connected is possible from the authenticated terminal and from the third network. Additionally, because there is no need to assign multiple addresses (Layer 3 addresses) to the terminal, address utilization efficiency may be improved. In the first aspect, the term “authentication” is used in a broad sense to include both authentication and quarantine.

### BRIEF DESCRIPTION OF THE DRAWINGS

FIG. 1 is an illustration depicting a configuration of a network system according to a first embodiment of the invention;

FIG. 2 is an illustration depicting the interface role class table shown in FIG. 1;

FIG. 3 is an illustration depicting the VRF determination table of FIG. 1 in the initial state;

FIG. 4 is an illustration depicting the initial state of the terminal VRF forwarding table shown in FIG. 1.

FIG. 5 is an illustration depicting the post-authentication VRF forwarding table shown in FIG. 1;

FIG. 6 is an illustration depicting in model form forwarding routes before and after successful authentication of a terminal;

FIG. 7 is a flowchart depicting the procedure of a packet forwarding process executed in the network system;

FIG. 8 is an illustration depicting the terminal VRF forwarding table subsequent to successful authentication of the first terminal;

FIG. 9 is an illustration depicting the post-authentication VRF forwarding table subsequent to successful authentication of the first terminal;

FIG. 10 is a flowchart depicting the procedure of the process of adding an entry to the VRF determination table taking place subsequent to successful authentication of a terminal;

FIG. 11 is an illustration depicting the VRF determination table containing the added entry for the first terminal subsequent to successful authentication of the first terminal;

FIG. 12 is an illustration depicting the procedure of an entry deletion process from the VRF determination table taking place in the packet forwarding device;

FIG. 13 is an illustration depicting a configuration of a network system according to a second embodiment of the invention;

FIG. 14 is an illustration depicting the interface role class table of Embodiment 2;

FIG. 15 is an illustration depicting the VRF determination table of Embodiment 2 in its initial state;

FIG. 16 is an illustration depicting the authentication VRF forwarding table of Embodiment 2 in its initial state;

FIG. 17 is an illustration depicting the first enterprise VRF forwarding table of Embodiment 2 in its initial state;

FIG. 18 is an illustration depicting the second enterprise VRF forwarding table of Embodiment 2 in its initial state;

FIG. 19 is an illustration depicting in model form forwarding routes before and after successful authentication of the first terminal in Embodiment 2;

FIG. 20 is an illustration depicting in model form forwarding routing before and after successful authentication of the second terminal in Embodiment 2;

FIG. 21 is a flowchart depicting the procedure of the packet forwarding process in Embodiment 2;

FIG. 22 is a flowchart depicting the procedure of the process for adding an entry to the VRF determination table in Embodiment 2;

FIG. 23 is an illustration depicting the VRF determination table after addition of entries for the first terminal and the second terminal, subsequent to successful authentication of these two terminals;

FIG. 24 is an illustration depicting the authentication VRF forwarding table subsequent to successful authentication of the first terminal and the second terminal;

FIG. 25 is an illustration depicting the first enterprise VRF forwarding table subsequent to successful authentication of the first terminal and the second terminal;

FIG. 26 is an illustration depicting the second enterprise VRF forwarding table subsequent to successful authentication of the first terminal and the second terminal;

FIG. 27 is an illustration depicting a configuration of a network system according to a third embodiment of the invention;

FIG. 28 is an illustration depicting the VRF determination table in Embodiment 3;

FIG. 29 is an illustration depicting the initial state of the first enterprise VRF forwarding table of Embodiment 4;

FIG. 30 is an illustration depicting the initial state of the second enterprise VRF forwarding table of Embodiment 4;

FIG. 31 is a flowchart depicting the procedure of the process for adding entries to the VRF determination table and the VRF forwarding tables in Embodiment 4;

FIG. 32 is an illustration depicting the first enterprise VRF forwarding table subsequent to execution of Step S220;

FIG. 33 is an illustration depicting the second enterprise VRF forwarding table subsequent to execution of Step S220;

FIG. 34 is a flowchart depicting the procedure of the entry deletion process of Embodiment 4;

FIG. 35 is an illustration depicting a configuration of a network system according to a fifth embodiment;

FIG. 36 is an illustration depicting the VRF determination table of Embodiment 5;

FIG. 37 is an illustration depicting the integrated VRF forwarding table of Embodiment 5;

FIG. 38 is a flowchart depicting the procedure of the packet forwarding process of Embodiment 5;

FIG. 39 is an illustration depicting the integrated VRF forwarding table subsequent to exchange of packets between the first terminal and the authentication server prior to successful authentication;

FIG. 40 is a flowchart depicting the entry update process in Embodiment 5;

FIG. 41 is an illustration depicting the VRF determination table after addition of entries for the first terminal and the second terminal, subsequent to successful authentication of these two terminals;

FIG. 42 is an illustration depicting the integrated VRF forwarding table subsequent to successful authentication for the first terminal and the second terminal; and

FIG. 43 is a flowchart depicting the procedure of the entry deletion process of Embodiment 5.

### DESCRIPTION OF THE PREFERRED EMBODIMENT

### A. Embodiment 1

### A1. System Configuration

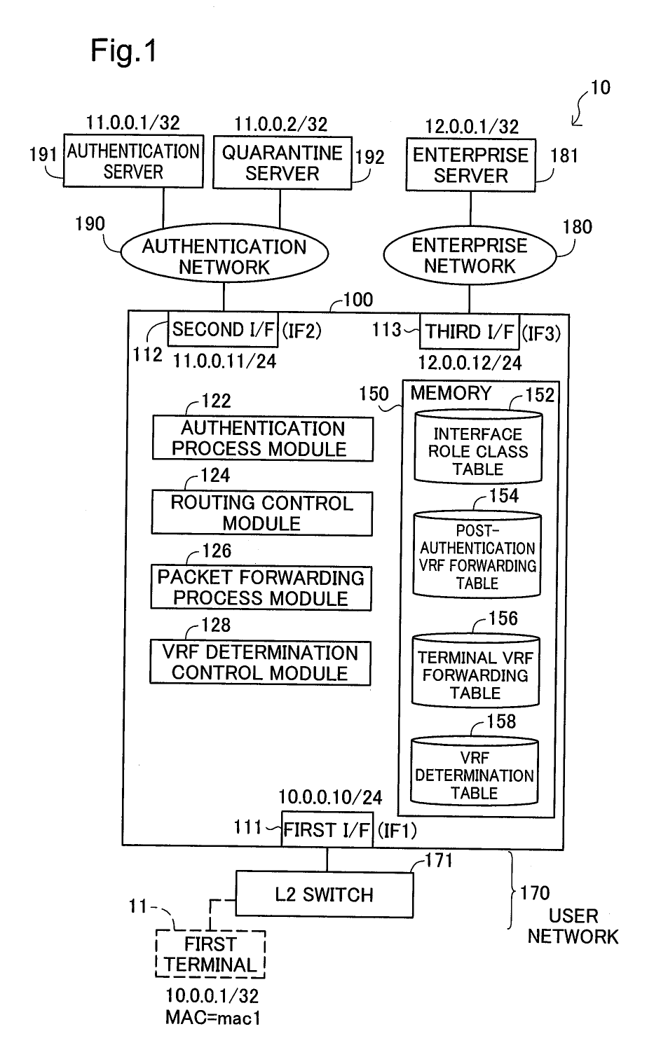

FIG. 1 is an illustration depicting a configuration of a network system according to a first embodiment of the invention. This network system 10 includes a packet forwarding device 100, a user network 170, a Layer 2 switch 171, an authentication network 190, an authentication server 191, a quarantine server 192, an enterprise network 180, and an enterprise server 181.

The packet forwarding device 100 is a Layer 3 switch adapted to forward packets in the third layer of the OSI model (the Network Layer). However, a router could be used in place of the Layer 3 switch. In the present embodiment, the third layer packets are IP (Internet Protocol) packets; however, IPX (Internetwork Packet eXchange) packets could be used in place of IP packets. Herein, third layer packets shall be referred to simply as “packets”.

The packet forwarding device 100 has three interfaces (a first interface 111, a second interface 112, and a third interface 113), a memory 150, an authentication process module 122, a routing control module 124, a packet forwarding process module 126, and a VRF determination control module 128.

The first interface 111 is an interface adapted to connect to the user network 170. The second interface 112 and the third interface 113 are interfaces adapted to connect to the authentication network 190 and to the enterprise network 180, respectively. These three interfaces 111 to 113 are all logical interfaces assigned IP addresses in a VLAN; however, they could also be physical interfaces such as Ethernet™.

The memory 150 stores an interface role class table 152, a post-authentication VRF forwarding table 154, a terminal VRF forwarding table 156, and a VRF determination table 158. The packet forwarding device 100 is adapted to implement VRF (Virtual Routing and Forwarding: a technique whereby multiple forwarding tables (routing tables) are maintained, and packets are forwarded in accordance with the tables). Thus, the packet forwarding device 100 is furnished with two forwarding tables (the post-authentication VRF forwarding table 154 and the terminal VRF forwarding table 156), and received packets are forwarded on the basis of these forwarding tables 154, 156. Each table will be discussed in detail later.

The authentication process module 122, the routing control module 124, the packet forwarding process module 126, and the VRF determination control module 128 are all function modules implemented through execution of a program stored in the memory 150, by a CPU (Central Processing Unit), not shown. An ASCI (Application Specific Integrated Circuit) could be used in place of the CPU.

The authentication process module 122 mediates communication between an unauthenticated terminal and the authentication server 191 or quarantine server 192. The authentication process module 122 notifies the VRF determination control module 128 of the results of authentication (authentication and quarantine) received from the authentication server 191 or quarantine server 192. The authentication process (authentication and quarantine) may employ protocols according to IEEE 802.1x or Web authentication for example.

The routing control module 124 controls packet forwarding routing through management of the post-authentication VRF forwarding table 154 and the terminal VRF forwarding table 156.

The packet forwarding process module 126 forwards packets received by the interfaces 111 to 113, doing so on the basis of the post-authentication VRF forwarding table 154 and the terminal VRF forwarding table 156.

The VRF determination control module 128 manages the VRF determination table 158, and from the post-authentication VRF forwarding table 154 and the terminal VRF forwarding table 156, determines which of these tables to search for the packet forwarding routing.

The user network 170 is a Layer 3 network (VLAN) to which a terminal (e.g. a personal computer) may belong. The Layer 2 switch 171 is a so-called switching hub that carries out switching of frames in the second layer (the Data Link Layer) in the user network 170. The first interface 111 is physically connected to the Layer 2 switch. The terminal belonging to the user network 170 is physically connected to this Layer 2 switch. In the example of FIG. 1, the first terminal 11 may belong to the user network 170.

The authentication network 190 is a Layer 3 network (VLAN) to which the authentication server 191 and the quarantine server 192 belong. On the basis of authentication elements (e.g. a login name and password) received from a terminal wishing to join the user network 170, the authentication server 191 carries out authentication of the terminal. The quarantine server 192 carries out quarantine for terminals wishing to join the user network 170, and decides whether a terminal meets certain security policies. The security policies may be that the virus definitions file is the most recent and that the operating system is the latest version, for example.

If authentication is successful and the terminal meets security policies, the aforementioned authentication server 191 determines that authentication was successful, and notifies the authentication process module 122 of successful authentication.

The enterprise network 180 is a Layer 3 network (VLAN) to which the enterprise server 181 belongs. The enterprise server 181 is the server accessed by a terminal subsequent to successful authentication.

In this instance, the terminal, the servers, and the interfaces 111 to 113 of the packet forwarding device 100 are pre-assigned IP addresses. Specifically, the first terminal 11 is assigned 10.0.0.1/32. The authentication server 191 is assigned 11.0.0.1/32; the quarantine server 192 11.0.0.2/32; the enterprise server 181 12.0.0.1/32; the first interface 111 10.0.0.10/24; the second interface 112 11.0.0.11/24; and the third interface 113 12.0.0.12/24, respectively. The above IP addresses are represented in CIDR (Classless Inter-Domain Routing) format.

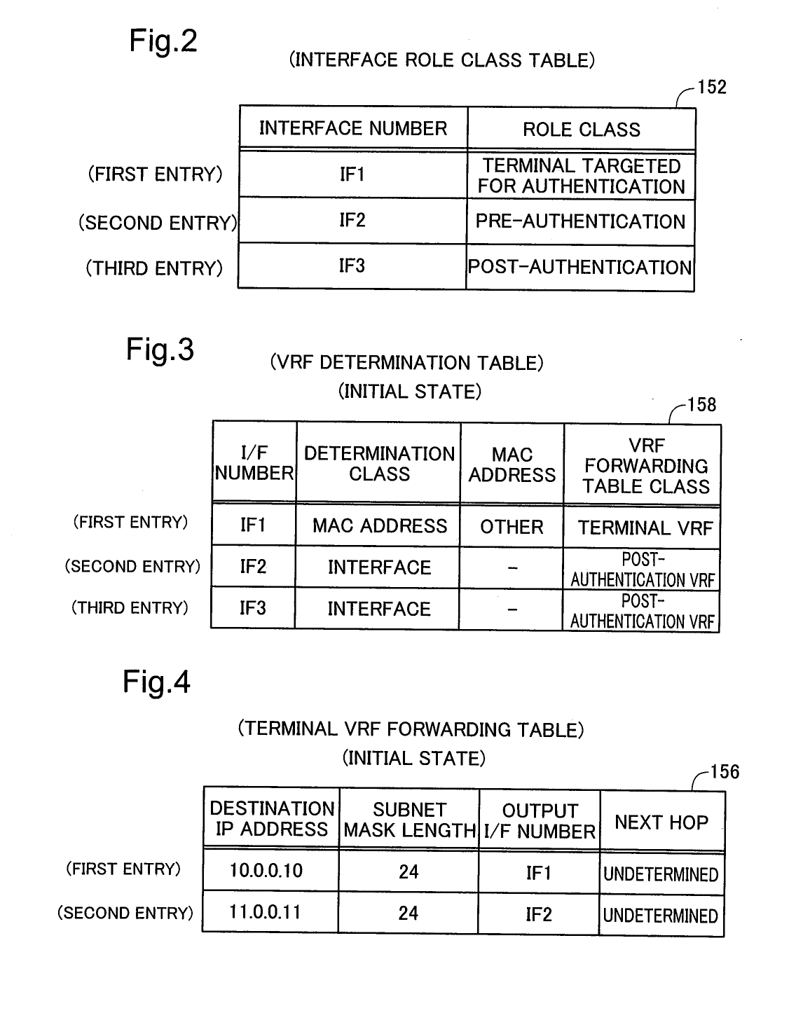

FIG. 2 is an illustration depicting the interface role class table 152 shown in FIG. 1. The interface role class table 152 is a table for managing role classes of the interfaces 111 to 113 of the packet forwarding device 100. The interface role class table 152 lists associations between “Interface Number” and “Role Classification”. The Interface Number field shows numbers indicating the interfaces 111 to 113. In the present embodiment, “IF1” is assigned as the interface number for the first interface 111. Likewise, “IF2” is assigned as the interface number for the second interface 112, and “IF3” as the interface number for the third interface 113, respectively. The Role Classification field indicates the role of each interface. The “Terminal Targeted for Authentication” value in the Role Classification field indicates that the interface is used to connect to a prescribed network to which a terminal undergoing authentication belongs. The “Pre-authentication” value in the Role Classification field indicates that the interface is used to connect to a network with which a terminal is allowed to communicate prior to authentication. The “Post-authentication” value in the Role Classification field indicates that the interface is used to connect to a network with which a terminal is allowed to communicate only after successful authentication.

In the example of FIG. 2, the first entry associates “Terminal Targeted for Authentication” with the first interface 111 (IF1). The second entry associates “Pre-authentication” with the second interface 112 (IF2), and the third entry associates “Post-authentication” with the third interface 113 (IF3), respectively. These entries are established beforehand by the system administrator, according to the roles of the interfaces 111 to 113.

FIG. 3 is an illustration depicting the VRF determination table 158 of FIG. 1 in the initial state. The VRF determination table 158 is a table for determining VRF forwarding tables in which to search for packet forwarding routing when the packet forwarding device 100 receives a packet. The VRF determination table 158 describes associations among “Interface Number”, “Determination Classification”, “MAC Address”, and “VRF Forwarding Table Classification”.

The Interface Number field is identical to the “Interface Number” in the interface role class table 152 discussed earlier. The Determination Classification field is an element (field) for deciding on an entry to reference when determining the VFR forwarding table. The “MAC Address” value in the Determination Classification field indicates that the MAC (Media Access Control) address of the packet sender should be used to determine the entry to reference. The “Interface” value in the Determination Classification field indicates that, regardless of the MAC address of the packet sender, the interface that received the packet should be used to decide on an entry to reference. The MAC Address field is an element specifying the MAC address, for the entry whose determination class is “MAC Address”. The VRF Forwarding Table Classification field specifies the VRF forwarding table to use to search for the packet forwarding routing.

In the example of FIG. 3, the first entry contains the determination class setting “MAC Address”, the MAC address setting “Other”, and the VRF forwarding table class setting “Terminal VRF Forwarding Table” respectively. A MAC address value of “Other” indicates that the entry whose Determination Classification field lists “MAC Address” contains as its MAC Address field value that “All other MAC addresses excepting MAC addresses specified in other entries”. The second entry contains the determination class setting “Interface”, the MAC address setting “−”, and the VRF forwarding table class setting “Post-authentication VRF Forwarding Table” respectively. The “−” setting for MAC address indicates that MAC addresses are not referenced. The third entry contains settings for each field for the third interface 113 (IF3), but is not discussed because the settings of the Determination Classification, MAC Address, and VRF Forwarding Table Classification fields are the same as those in the second entry.

In the initial state, these three entries (first to third entries) are established in the VRF determination table 158. These three entries are generated by the VRF determination control module 128 during initial configuration of the network system 10. Specifically, the VRF determination control module 128 looks up in the interface role class table 152 shown in FIG. 2, and acquires the role classes that were established for the interfaces 111 to 113. Next, for the interface whose role class is “Terminal Targeted for Authentication”, the VRF determination control module 128 adds to the VRF determination table 158 an entry containing the settings “MAC Address” for determination class, “Other” for MAC Address, and “Terminal VRF Forwarding Table” for VRF forwarding table class, respectively. For the interfaces whose role classes are “Pre-authentication” and “Post-authentication”, the VRF determination control module 128 adds to the VRF determination table 158 entries containing the settings “Interface” for determination class, “−” for MAC Address, and “Post-authentication VRF Forwarding Table” for VRF forwarding table class, respectively. In this way, the first to third entries shown in FIG. 3 are added to the VRF determination table 158. Entries in the VRF determination table 158 may also be made after initial configuration, as will be discussed later.

FIG. 4 is an illustration depicting the initial state of the terminal VRF forwarding table 156 shown in FIG. 1. The terminal VRF forwarding table 156 is a table used to search for forwarding routing during forwarding of packets received from a terminal prior to authentication. The terminal VRF forwarding table 156 describes associations among “Destination IP Address”, “Subnet Mask Length”, “Output Interface Number”, and “Next Hop”. The “Destination IP Address” and “Subnet Mask Length” indicate the destination IP address and subnet mask length obtained from the header of packets received by the packet forwarding device 100. The “Output Interface Number” indicates the interface that forwards (outputs) the received IP address. “Next Hop” indicates the MAC address of the specific sender of the packet. Possible settings in the “Next Hop” field are the MAC address of each device, as well as an “Undetermined” setting. A setting of “Undetermined” for next hop address indicates that the MAC address was not resolved.

In the example of FIG. 4, the first entry contains the settings “10.0.0.10” for destination IP address, “24” for subnet length, “IF1” for output interface number, and “Undetermined” for next hop address. This means that while packets destined for “10.0.0.10/24” (i.e. to inside the user network 170) are transferred to the first interface 111, the specific destination device is “Undetermined”. The second entry contains the settings “11.0.0.11” for destination IP address, “24” for subnet length, “IF2” for output interface number, and “Undetermined” for next hop address. This means that while packets destined for “11.0.0.11/24” (i.e. to inside the authentication network 190) are transferred to the second interface 112, the specific destination device is “Undetermined”.

In the initial state, these two entries (first and second entries) are established in the terminal VRF forwarding table 156. These two entries are generated by the routing control module 124 during initial configuration of the network system 10. Specifically, the routing control module 124 looks up in the interface role class table 152 shown in FIG. 2, and acquires the role classes that were established for the interfaces 111 to 113. Next, for the interfaces whose role classes are “Terminal Targeted for Authentication” and “Pre-authentication”, on the basis of the respective IP address, subnet mask, and interface number settings for these interfaces, the routing control module 124 adds to the terminal VRF forwarding table 156 entries describing “Destination IP Address”, “Subnet Mask Length”, and “Interface Number” fields, and the next hop address as “Undetermined”. In this way, the first and second entries depicted in FIG. 4 are added to the terminal VRF forwarding table 156. As will be discussed later, the terminal VRF forwarding table 156 entries may also be added after initial configuration.

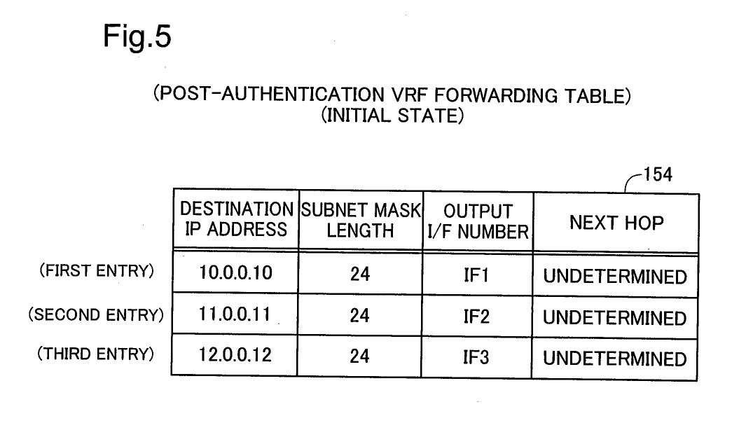

FIG. 5 is an illustration depicting the post-authentication VRF forwarding table 154 shown in FIG. 1, in the initial state. The post-authentication VRF forwarding table 154 is a table used to search for forwarding routing during forwarding of packets received from a successfully authenticated terminal, from the authentication server 191, from the quarantine server 192, and from the enterprise server 181. The fields in the post-authentication VRF forwarding table 154 have the same meanings as the fields in the terminal VRF forwarding table 156 (FIG. 4) and require no further description. The first and second entries in FIG. 5 are identical to the first and second entries in the terminal VRF forwarding table 156 discussed earlier, and require no further description.

In the example of FIG. 5, the third entry contains the settings “12.0.0.12” for destination IP address, “24” for subnet length, “IF3” for output interface number, and “Undetermined” for next hop address. This means that while packets destined for “12.0.0.12/24” (i.e. the enterprise network 180) are transferred to the third interface 113, the specific destination device is “Undetermined”.

In the initial state, these three entries (first to third entries) are established in the post-authentication VRF forwarding table 154. These three entries are generated by the routing control module 124 during initial configuration of the network system 10. Specifically, the routing control module 124 looks up in the interface role class table 152 shown in FIG. 2, and acquires the role classes that were established for the interfaces 111 to 113. Next, for interfaces for which any of the role classes have been established, on the basis of the respective IP address, subnet mask, and interface number settings for these interfaces, the routing control module 124 adds to the post-authentication VRF forwarding table 154 entries describing “Destination IP Address”, “Subnet Mask Length”, and “Interface Number” fields, and the next hop address as “Undetermined”. In this way, the first to third entries depicted in FIG. 5 are added to the post-authentication VRF forwarding table 154. As will be discussed later, the post-authentication VRF forwarding table 154 entries may also be added after initial configuration.

The packet forwarding device 100 corresponds to the packet forwarding apparatus recited in the claims. The aforementioned user network 170 corresponds to the first network recited in the claims. The authentication network 190 corresponds to the second network recited in the claims, the enterprise network 180 to the third network recited in the claims, the terminal VRF forwarding table 156 to the first forwarding route table recited in the claims, the post-authentication VRF forwarding table 154 to the second forwarding route table recited in the claims, the VRF determination table 158 to the search forwarding route table determination table recited in the claims, the memory 150 to the forwarding route table storage recited in the claims, the VRF determination control module 128 to the table updater, the forwarding route table selector, and the forwarding route selector recited in the claims, and the routing control module 124 to the forwarding route table updater recited in the claims, respectively.

### A2. Overview of Forwarding Route Changes Before/After Successful Authentication

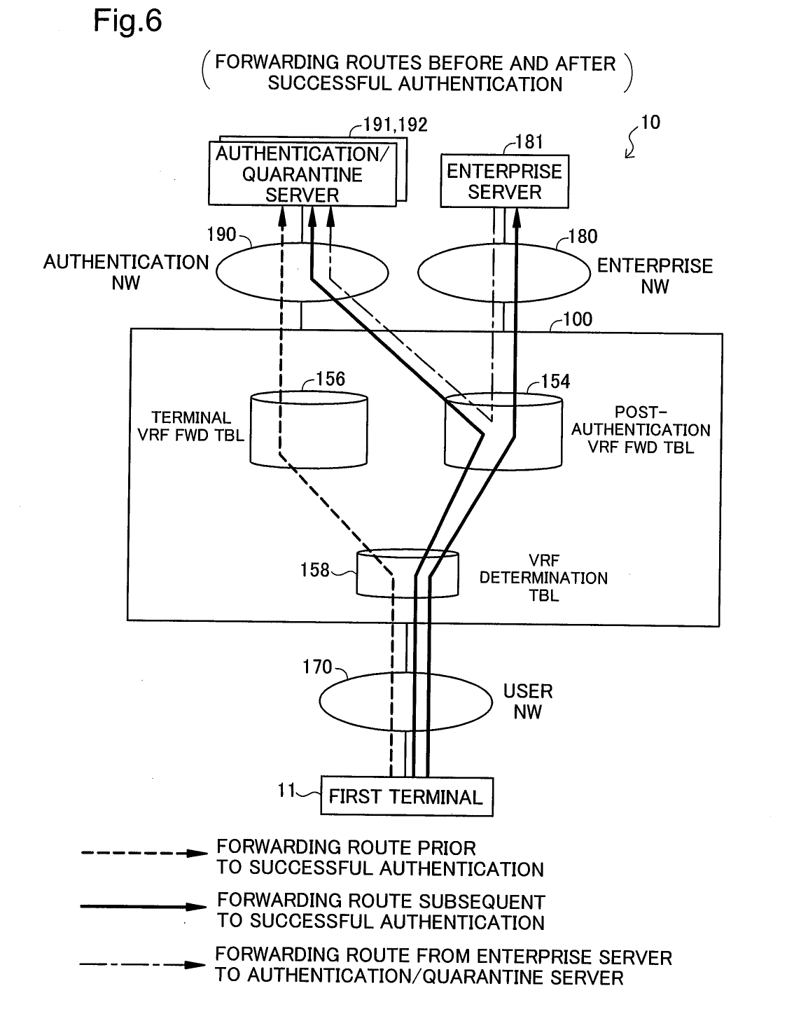

FIG. 6 is an illustration depicting in model form forwarding routes before and after successful authentication of a terminal. In the network system 10, by making the initial settings in the tables 154, 156, 158 discussed above, and carrying out a VRF determination table 158 entry addition process and a packet forwarding process discussed later, prior to successful authentication the terminal can only access the authentication network 190, whereas subsequent to successful authentication the terminal can access the authentication network 190 in addition to the enterprise network 180. First, an overview of forwarding route changes of packets sent from the terminal is discussed with reference to FIG. 6, and then the packet forwarding process and the VRF determination table entry addition process are discussed in detail.

Of the various elements that make up the packet forwarding device 100, FIG. 6 depicts only the VRF determination table 158, the terminal VRF forwarding table 156, and the post-authentication VRF forwarding table 154, with the other elements being omitted. In FIG. 6, the broken line arrow indicates forwarding routing of packets sent from the first terminal prior to successful authentication. The solid line arrow indicates forwarding routing of packets sent from the first terminal subsequent to successful authentication, and the dot-and-dash line arrow indicates forwarding routing of packets sent from the enterprise server 181 to the authentication server 191 and the quarantine server 192 before and after successful authentication.

Prior to successful authentication, forwarding routing for packets from the first terminal 11 is determined by searching in the terminal VRF forwarding table 156 on the basis of the VRF determination table 158. Here, because the terminal VRF forwarding table 156 describes forwarding routing to devices in the authentication network 190, as indicated by the broken line arrow, packets are forwarded to the authentication server 191 and to the quarantine server 192. Because forwarding routing to the enterprise network 180 is not described in the terminal VRF forwarding table 156, prior to successful authentication, packets from the first terminal 11 cannot be forwarded to the enterprise network 180.

Upon successful authentication, the VRF determination table 158 is updated, and forwarding routing for packets from the first terminal 11 is determined by searching in the post-authentication forwarding table 154. Here, because the post-authentication VRF forwarding table 154 describes forwarding routing to the enterprise network 180 and the authentication network 190, as indicated by the solid line arrow, subsequent to successful authentication, packets from the first terminal 11 are forwarded to the enterprise server 181, the authentication server 191, and the quarantine server 192.

While forwarding routing for packets from the enterprise network 180 to the authentication network 190 is omitted in the drawing, it is determined by looking up in the VRF determination table 158, and searching in the post-authentication VRF forwarding table 154 irrespective of successful authentication of the terminal.

### A3. Operation During Terminal Authentication

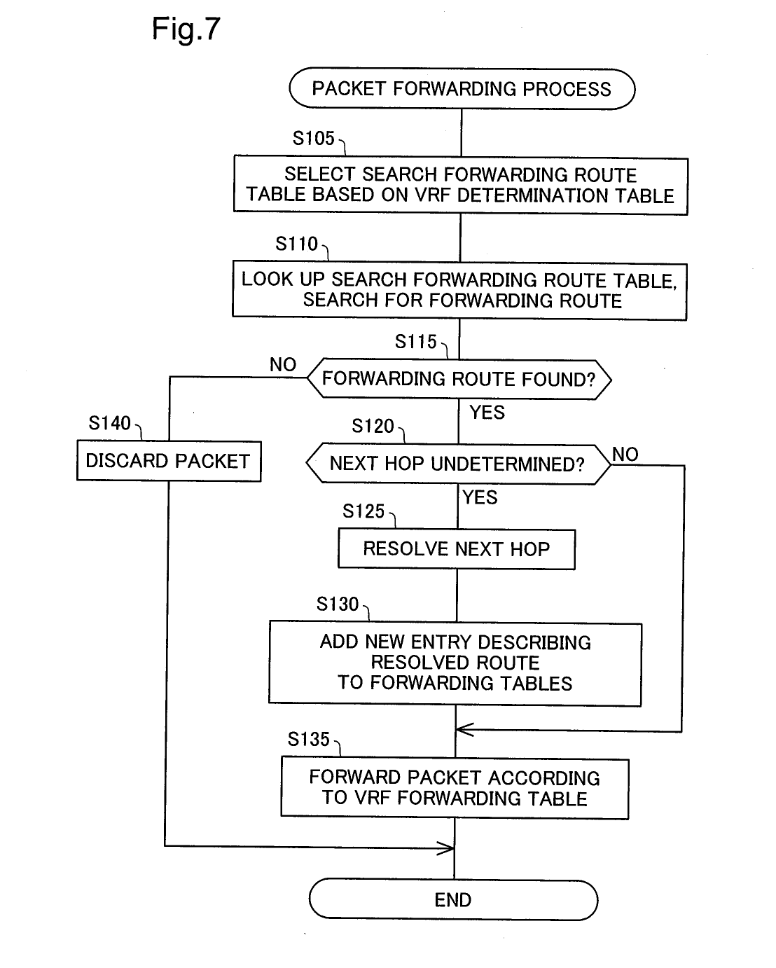

FIG. 7 is a flowchart depicting the procedure of a packet forwarding process executed in the network system 10. When the first terminal 11 joins the user network 170, the first terminal 11 sends the packet forwarding device 100 a packet addressed to the authentication server 191 (e.g. a packet containing a login name and password). When the packet forwarding device 100 receives the packet, it initiates the packet forwarding process. For configurations in which IP addresses are assigned by DHCP (Dynamic Host Configuration Protocol) rather than IP addresses being assigned beforehand, after IP addresses are assigned by DHCP as part of the authentication process, the packet forwarding process may be initiated when an authentication packet is sent to the authentication server 191.

First, the VRF determination control module 128 looks up in the VRF determination table 158 and decides upon a VRF forwarding table to use for searching for forwarding routing of the packet that arrived (hereinafter termed the “search VRF forwarding table”) (Step S105). Prior to successful authentication of the first terminal 11, the settings in the VRF determination table 158 are in the initial state depicted in FIG. 3. Consequently, for packets sent from the first terminal 11 prior to successful authentication, a first entry specifying that the interface number is “IF1”, the determination class is “MAC address”, and the MAC address is “Other” is found, and the terminal VRF forwarding table 156 is selected as the VRF forwarding table to be used for searching for the forwarding routing.

Once the search VRF forwarding table has been selected, the packet forwarding process module 126 looks up in the VRT forwarding table that was selected in Step S105, searches for a forwarding route (Step S110), and determines if a forwarding route was found (Step S115). For packets sent from the first terminal 11 prior to authentication, because the terminal VRF forwarding table 156 is selected as the search VRF forwarding table, the packet forwarding process module 126 searches for a forwarding route from the terminal VRF forwarding table 156. At this time, the terminal VRF forwarding table 156 contains the initial state settings depicted in FIG. 4.

The search for a forwarding route in the search VRF forwarding table is carried out by the so-called longest match search method. Specifically, from among the entries in the search VRF forwarding table, a search is made for entries in which the values of the upper bits indicating subnet mask length in the destination IP address match the values of the upper bits indicating subnet mask length in the destination IP address of the received packet, and the entry with the most matching bits is selected. Prior to successful authentication, packets received from the first terminal 11 are addressed to the authentication server 191 (11.0.0.1/32), so in this instance the second entry shown in FIG. 4 is found.

If a forwarding route is found (Step S115: YES), the packet forwarding process module 126 determines whether the next hop in the found forwarding route is undetermined (unresolved) (Step S120), and if the next hop is undetermined, controls the routing control module 124 and resolves the next hop (Step S125). In the second entry shown in FIG. 4, the next hop is “Undetermined”, so the packet forwarding process module 126 resolves the next hop. Resolution involving ARP (Address Resolution Protocol) carried out by the routing control module 124 may be employed as the method for resolving the next hop.

Once the next hop to the authentication server 191 is resolved as a result of Step S125, the routing control module 124 adds to the VRF forwarding table that was selected in Step S105 a new entry describing the resolved next hop value (Step S130).

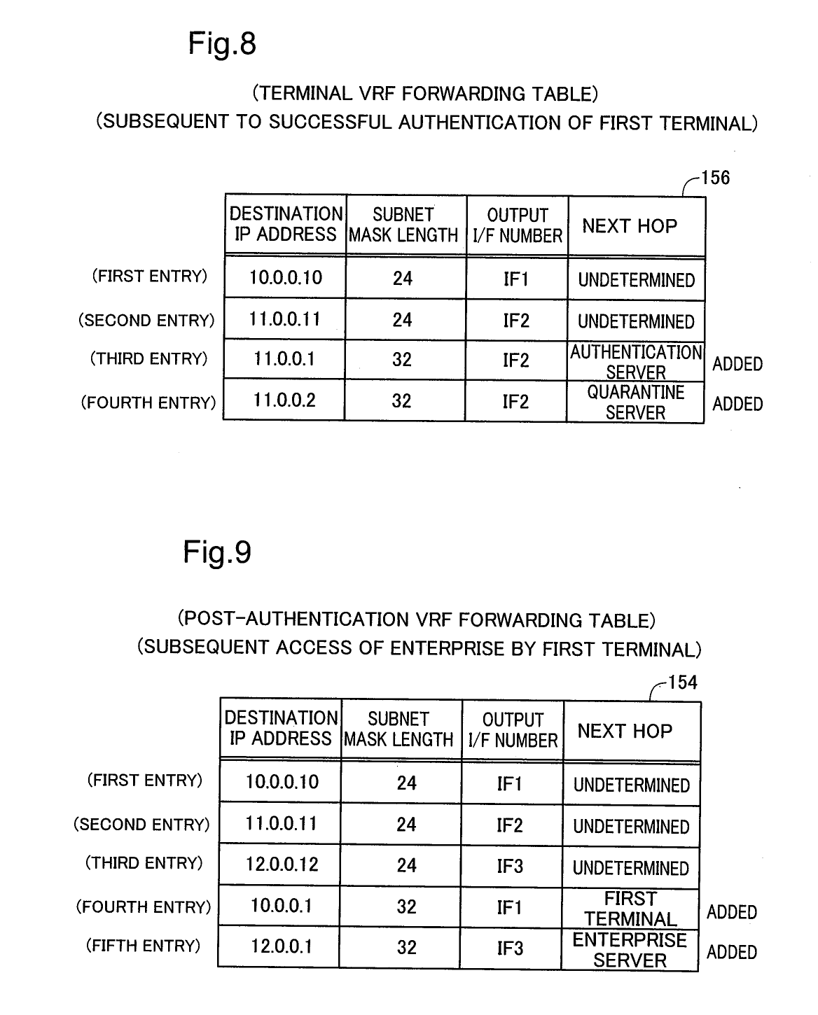

FIG. 8 is an illustration depicting the terminal VRF forwarding table 156 subsequent to successful authentication of the first terminal 11. FIG. 8 shows the terminal VRF forwarding table 156 subsequent to both successful authentication and quarantine of the first terminal 11. As mentioned previously, the third entry shown in FIG. 8 (the specific forwarding route to the authentication 191) is added at a point in time subsequent to Step S130 of the packet forwarding process which takes place prior to successful authentication of the first terminal 11. At this point in time, the fourth entry has not been added. As indicated by the third entry in FIG. 8, the new entry that is added during the authentication operation of the first terminal 11 specifies a destination IP address of “11.0.0.1” (the IP address of the authentication server 191), a subnet mask length of “32”, an output interface number of “IF2”, and “authentication server (MAC address)” as the next hop, respectively.

Once the new entry (forwarding route) is added to the VRF forwarding table in Step S130, the packet received by the packet forwarding process module 126 is forwarded according to the VRF forwarding table (Step S135). In this way, the packet that is addressed to the authentication server 191 is forwarded to the authentication server 191 in accordance with the forwarding route described by the third entry shown in FIG. 8.

In Step S115 mentioned above, if no forwarding route is found, the packet forwarding process module 126 discards the received packet (Step S140). If the next hop was found to be already resolved in Steps S120, Step S125 and S130 are skipped, and Step S135 is executed.

When the authentication packet arrives at the authentication server 191 in this way, the authentication server 191 carries out the authentication process, and an authentication packet is sent from the authentication server 191 to the first terminal 11. In this instance as well, the packet is forwarded in accordance with the packet forwarding process discussed previously. In Step S105, in accordance with the second entry in the VRF determination table 158 of FIG. 3, the post-authentication VRF forwarding table 154 is selected as the search VRF forwarding table. In Step S110, the first entry of the post-authentication VRF forwarding table 154 shown in FIG. 5 is found as the forwarding route to the first terminal 11; and since the next hop is undetermined, in Step S125 the next hop to the first terminal 11 is resolved. Subsequently, upon successful authentication and transmission of a quarantine packet from the first terminal 11 to the quarantine server 192, the fourth entry depicted in FIG. 8 is added to the terminal VRF forwarding table 156.

FIG. 9 is an illustration depicting the post-authentication VRF forwarding table 154 subsequent to successful authentication of the first terminal 11. FIG. 9 shows the post-authentication VRF forwarding table 154 subsequent to both successful authentication and quarantine of the first terminal 11, and subsequent to the first terminal 11 having accessed the enterprise server 181. As mentioned previously, if the next hop to the first terminal 11 was resolved, in Step S130 a fourth entry is added to the post-authentication VRF forwarding table 154. Then, in Step S135, the authentication packet is forwarded to the first terminal 11. The fifth entry is not added before the enterprise server 181 is accessed subsequent to successful authentication and quarantine.

Once authentication by the authentication server 191 is successful, next, quarantine is carried out by the quarantine server 192. The procedure for quarantine is identical to the procedure for authentication by the authentication server 191 discussed previously, so description is omitted here. Subsequent to successful authentication and quarantine, the terminal VRF forwarding table 156 contains the first to fourth entries as shown in FIG. 8. If authentication and quarantine are successful, the authentication server 191 notifies the authentication process module 122 that authentication (authentication and quarantine) was successful, and the authentication process module 122 notifies the VRF determination control module 128 that authentication was successful.

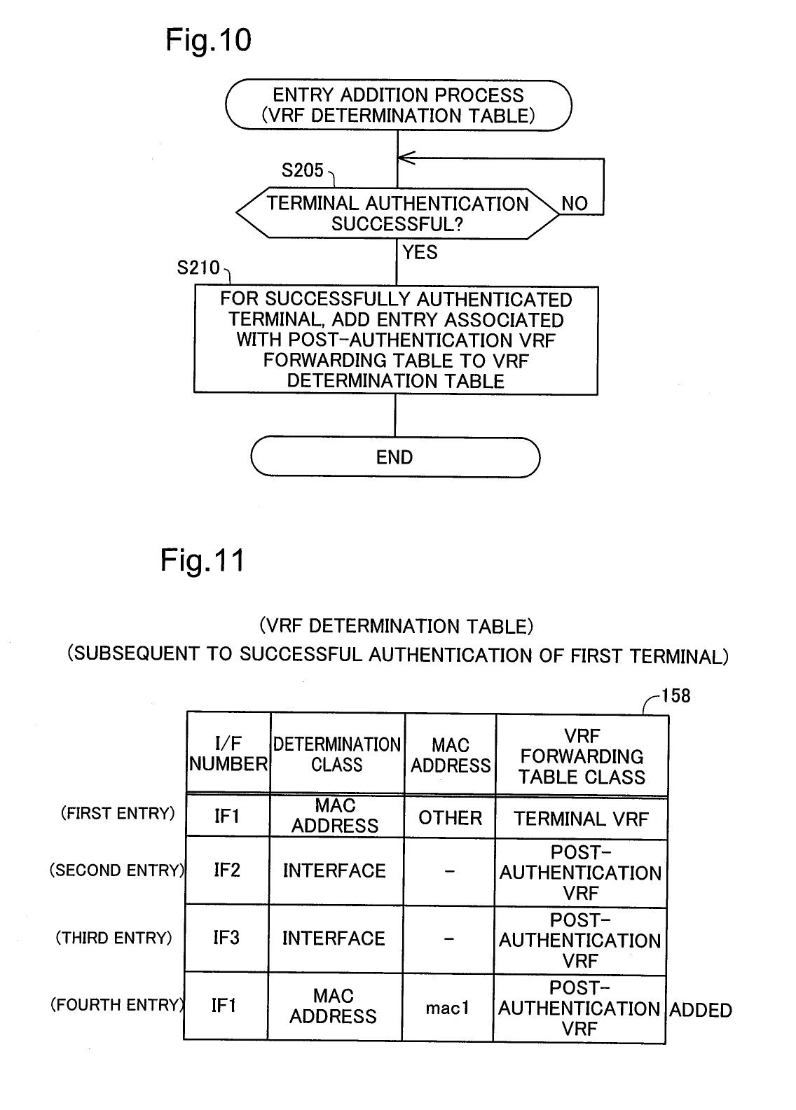

FIG. 10 is a flowchart depicting the procedure of the process of adding an entry to the VRF determination table taking place subsequent to successful authentication of a terminal. After successful authentication of the terminal, the VRF determination control module 128 executes an entry addition process to the VRF determination table 158.

Specifically, the VRF determination control module 128 waits for successful authentication (authentication and quarantine) for the terminal that has joined the user network 170 (Step S205). Upon receiving notification of successful authentication from the authentication process module 122, the VRF determination control module 128 adds to the VRF determination table 158 an entry corresponding to the post-authentication VRF forwarding table 154, for the successfully authenticated terminal (Step S210).

FIG. 11 is an illustration depicting the VRF determination table 158 containing the added entry for the first terminal 11 subsequent to successful authentication of the first terminal 11. As noted, if authentication of the first terminal 11 was successful, the VRF determination control module 128 adds the fourth entry depicted in FIG. 11. This fourth entry differs from the first entry in that the MAC Address field and the VRF Forwarding Table Classification field have different values; other fields have the same values as the first entry. Specifically, in the fourth entry, the MAC address of the first terminal 11 “mac1” is set in the MAC Address field, and the post-authentication VRF forwarding table 154 is set in the VRF Forwarding Table Classification field. By adding this fourth entry to the VRF determination table 158 subsequent to successful authentication of the first terminal 11, the first terminal 11 can access the enterprise server 181 in the enterprise network 180.

### A4. Packet Forwarding Process After Successful Terminal Authentication

The description now turns to the operation when a packet is sent from the first terminal 11 to the enterprise server 181 subsequent to successful authentication. In this instance as well, when a packet is received from the first terminal 11, the packet forwarding process depicted in FIG. 7 is executed in the packet forwarding device 100. In Step S105, because the packet is received from the first terminal 11 (MAC address=mac1), based on the fourth entry in the VRF determination table 158 shown in FIG. 11, the post-authentication VRF forwarding table 154 is selected as the search VRF forwarding table. In this case, during execution of Step S110, because there is currently no fifth entry in the post-authentication VRF forwarding table 154, the third entry is found. In the third entry the next hop is undetermined, so the next hop is resolved in Step S125, and then in Step S130 an entry specifying the “Enterprise Server” as the next hop (fifth entry) is added to the post-authentication VRF forwarding table 154. Consequently, in Step S135, the packet from the first terminal 11 is forwarded to the enterprise server 181 in accordance with the fifth entry in the terminal VRF forwarding table 154.

In the same way as prior to successful authentication, after successful authentication the first terminal 11 is able to access the authentication network 190 (the authentication server 192 and the quarantine server 192). Specifically, the discussion here relates to the case when a packet is sent from the first terminal 11 to the authentication server 191. In this case, when the packet is received from the first terminal 11, the packet transfer process shown in FIG. 7 is executed in the packet forwarding device 100. In Step S105, in a manner comparable to accessing the enterprise server 181 as described above, the post-authentication VRF forwarding table 154 is selected as the search VRF forwarding table. In Step S110, because the post-authentication VRF forwarding table 154 shown in FIG. 9 does not currently contain a forwarding route to the authentication server 191, the second entry is found. In the second entry the next hop is undetermined, so the next hop is resolved in Step S125, and then in Step S130 an entry specifying the “Authentication Server” as the next hop (not shown) is added to the post-authentication VRF forwarding table 154. Consequently, in Step S135, the packet from the first terminal 11 is forwarded to the authentication server 191 in accordance with this newly added entry.

In this way, a terminal joining the user network 170 is able to access the authentication network 190 (the authentication server 192 and the quarantine server 192) both before and after successful authentication. Consequently, even for a terminal that was already successfully authenticated, authentication and quarantine can nevertheless take place on a periodic or as-needed basis, so security in the network system 10 can be enhanced.

The authentication network 190 (the authentication server 192 and the quarantine server 192) can be accessed from the enterprise server 181 irrespective of whether there is successful authentication of a terminal. The reason is as follows. As depicted in FIGS. 3 and 11, the VRF forwarding table used for the packet forwarding route search from the enterprise server 181 is set to the post-authentication VRF forwarding table 154 (third entry) in the VRF determination table 158. As shown in FIGS. 5 and 9, in the post-authentication VRF forwarding table 154, the entry containing the IP address of the second interface 112 to which the authentication network is connected (the second entry) is described as by way of the destination IP address. Consequently, by resolving the next hop, an entry that describes the forwarding route to devices in the authentication network 190 (the authentication server 192 and the quarantine server 192) can be added.

### A5. VRF Determination Table Entry Deletion Process

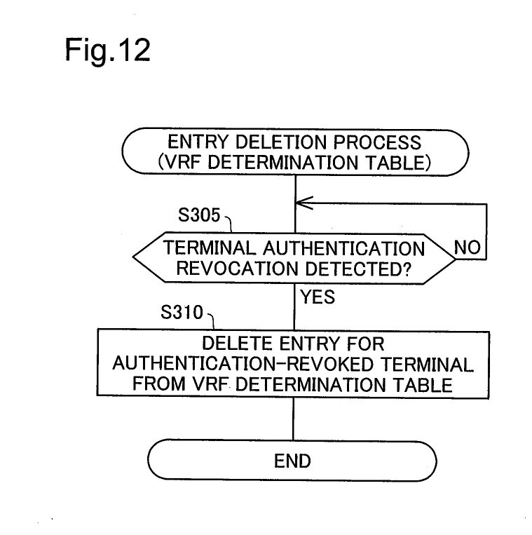

FIG. 12 is an illustration depicting the procedure of an entry deletion process from the VRF determination table 158 taking place in the packet forwarding device 100. Subsequent to successful authentication of a terminal, the VRF determination control module 128 initiates the entry deletion process from the VRF determination table 158. First, the VRF determination control module 128 waits until revocation of a terminal's authentication is detected (Step S305).

Revocation of a terminal's authentication may take place in a case where, for example, the user has logged off from the terminal, or in the event it is determined that authentication or quarantine taking place on a periodic basis subsequent to successful authentication has failed. In such instances, the authentication process module 122 notifies the VRF determination control module 128 of the MAC address of the terminal that experience authentication failure (revoked authentication) and of the fact that authentication was revoked.

Once until revocation of a terminal's authentication is detected, the VRF determination control module 128 deletes from the VRF determination table 158 the entry for the terminal having the MAC address of which it was notified (Step S310). For example, if authentication of the first terminal 11 was revoked, the VRF determination control module 128 deletes the fourth entry from the VRF determination table 158 shown in FIG. 11. As a result, the VRF determination table 158 returns to the initial state depicted in FIG. 3.

Consequently, if the first terminal 11 subsequently joins the user network 170, on the basis of the VRF determination table 158 (the first entry), the terminal VRF forwarding table 156 is selected as the search VRF forwarding table. Thus, the first terminal 11 is unable to access the enterprise network 180 (the enterprise server 181) until it is determined that re-authentication was successful. The VRF determination table entry deletion process described above can be dispensed with by adopting a policy whereby “once a terminal is authenticated, authenticated status is maintained even after logoff of the terminal”.

As described above, in the network system 10 of Embodiment 1, prior to successful authentication, the VRF determination table 158 contains an entry such that the terminal VRF forwarding table 156 is selected as the search VRF forwarding table for packets from the first terminal 11. The terminal VRF forwarding table 156 describes entries (first and second entries) that specify the IP addresses of the first and second interfaces 111, 112 in the Destination IP Address field. Consequently, prior to successful authentication, while the terminal can resolve the next hop and access the user network 170 and the authentication network 190 (the authentication server 192 and the quarantine server 192), it cannot access the enterprise network 180 (the enterprise server 181). Thus, access to the enterprise server 181 by the terminal prior to authentication can be prevented.

Subsequent to successful authentication, an entry is added to the VRF determination table 158 such that the post-authentication VRF forwarding table 154 is selected as the search VRF forwarding table for packets from the first terminal 11. Additionally, the post-authentication VRF forwarding table 156 describes entries (second and third entries) that specify the IP addresses of the second and third interfaces 112, 113 in the Destination IP Address field. Consequently, subsequent to successful authentication, the terminal can resolve the next hop and access the enterprise network 180 (the enterprise server 181), and can also access the authentication network 190 (the authentication server 191 and the quarantine server 192). Consequently, for the successfully authenticated terminal, authentication and quarantine can be carried out by the authentication server 191 and the quarantine server 192 on a periodic or as-needed basis.

Moreover, in the network system 10, a single IP address is assigned to the first terminal 11, and the utilization efficiency of IP addresses is accordingly higher as compared to an arrangement whereby different IP addresses are assigned to the first terminal 11 before and after authentication.

If authentication is revoked, access to the enterprise network 180 by the terminal whose authentication was revoked can be restricted simply by deleting from the VRF determination table 158 the entry that was created during successful authentication. Consequently, access can be restricted according to authentication results through a simple arrangement, and building costs and operating costs of the network system 10 can be kept to a minimum.

### B. Embodiment 2

### B1. System Configuration

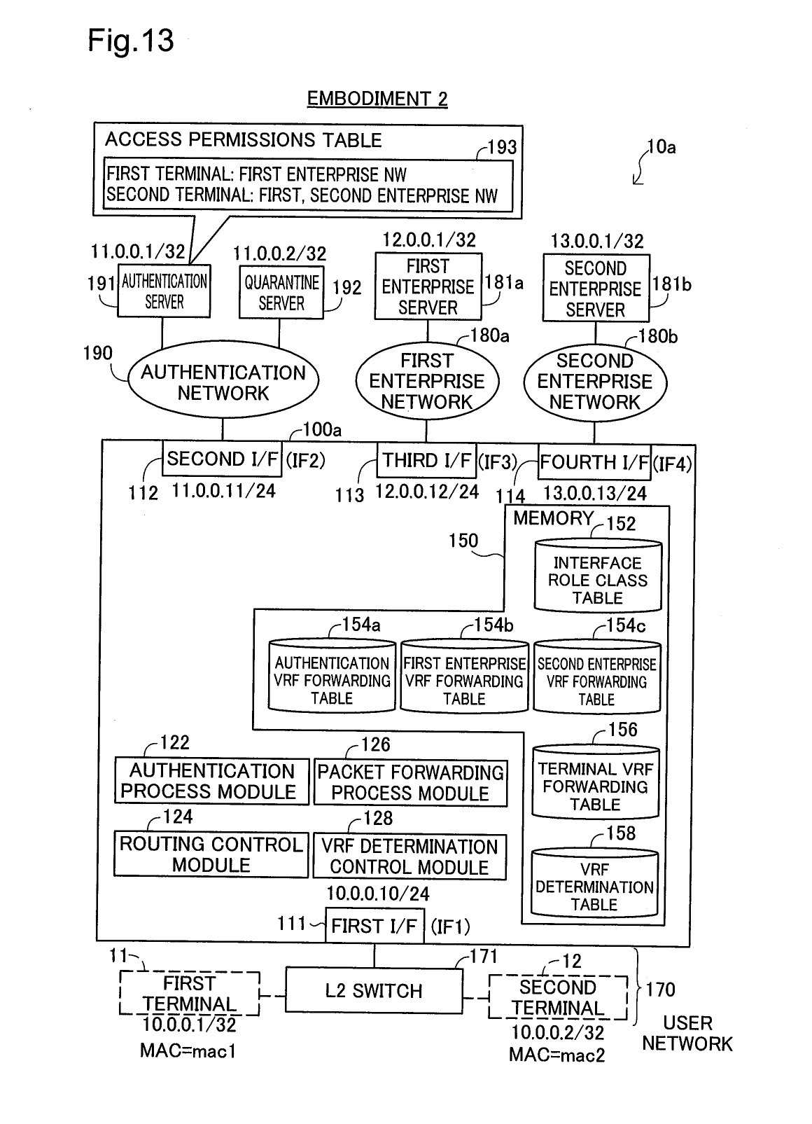

FIG. 13 is an illustration depicting a configuration of a network system 10a according to a second embodiment of the invention. The following five features of the network system 10a of Embodiment 2 differ from the network system 10 of Embodiment 1, but the configuration is otherwise the same as Embodiment 1. Specifically, the packet forwarding device 100a of Embodiment 2 differs from the network system 10 of Embodiment 1 in that: a fourth interface 114 is provided in addition to the first to third interfaces 111 to 113; the post-authentication VRF forwarding table 154 is replaced by an authentication VRF forwarding table 154a, a first enterprise VRF forwarding table 154b, and a second enterprise VRF forwarding table 154c; the enterprise network 180 is replaced by two enterprise networks (a first enterprise network 180a and a second enterprise network 180b); a second terminal 12 may join the user network 170 in addition to the first terminal 11; and the authentication server 191 is provided with an access permissions table 193.

The fourth interface 114 is an interface adapted to connect to the second enterprise network 180b. The network that is connected to the third interface 113 is termed the first enterprise network 180a. These two enterprise networks 180a, 180b both have the same role as the enterprise network 180 of Embodiment 1. A first enterprise server 181a belongs to the first enterprise network 180a, and a second enterprise server 181b belongs to the second enterprise network 180b.

As in Embodiment 1, IP addresses are pre-assigned to the terminals, the servers, and the interfaces of the packet forwarding device 100a. Specifically, the fourth interface 114 is assigned the address 13.0.0.13/24. The first enterprise server 181a is assigned the address 12.0.0.1/32, the second enterprise server 181b 13.0.0.1/32, and the second terminal 12 10.0.0.2/32, respectively. The MAC address “mac2” is established for the second terminal 12.

The authentication VRF forwarding table 154a is a table used to search for a forwarding route for packets received from devices belonging to the authentication network 190 (the authentication server 191 and the quarantine server 192). The first enterprise VRF forwarding table 154b is a table used to search for a forwarding route for packets received from a device belonging to the first enterprise network 180a (the first enterprise server 181a) and from the two terminals 11, 12 subsequent to successful authentication. The second enterprise VRF forwarding table 154c is a table used to search for a forwarding route for packets received from a device belonging to the second enterprise network 180b (the second enterprise server 181b) and from the second terminal 12 subsequent to successful authentication.

As shown in FIG. 13, the access permissions table 193 provided to the authentication server 191 describes associations between terminals that may join the user network 170, and network access permissions. Specifically, the first enterprise network 180a is associated with the first terminal 11, and both the first enterprise network 180a and the second enterprise network 180b are associated with the second terminal 12. This access permissions table 193 is set up by the network administrator during initial configuration of the network system 10.

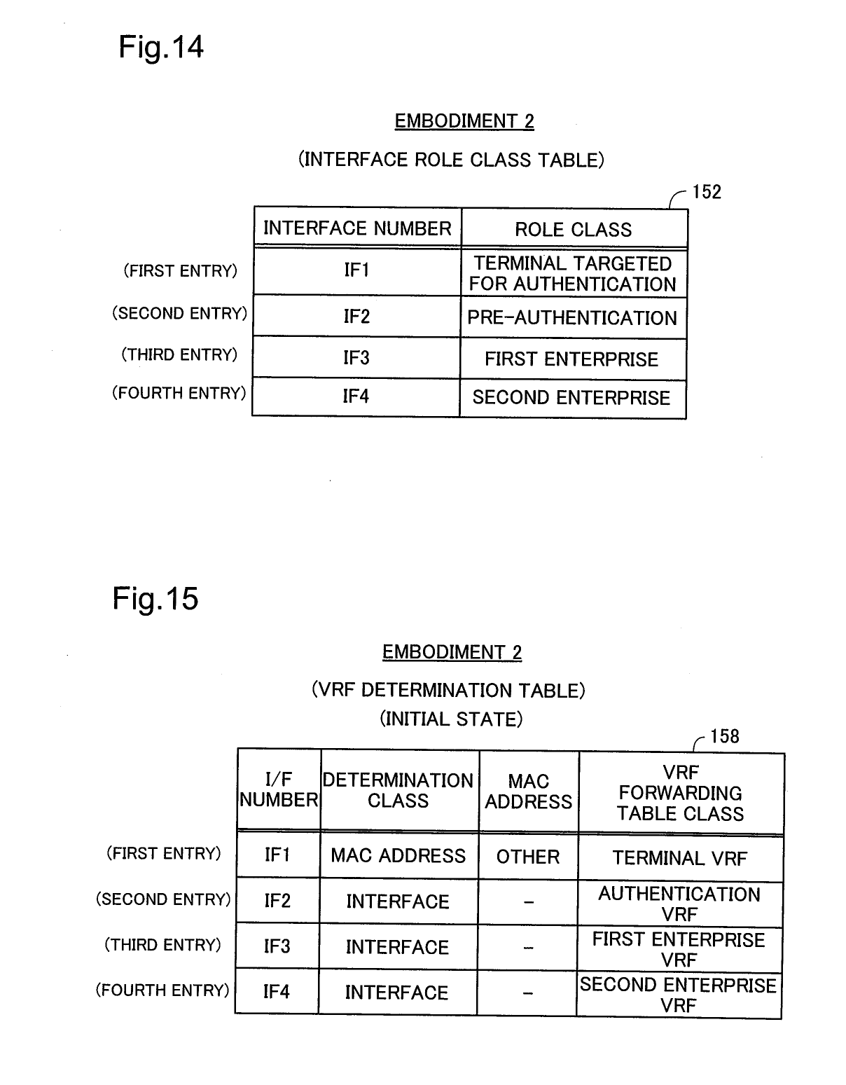

FIG. 14 is an illustration depicting the interface role class table 152 of Embodiment 2. The interface role class table 152 of Embodiment 2 differs from the interface role class table 152 of Embodiment 1 shown in FIG. 2 in that the second entry contains the role class “Pre-authentication”, the third entry contains the role class “First Enterprise”, and the fourth entry contains the interface number “IF4” and the role class “Second Enterprise”; the configuration is otherwise the same as in Embodiment 1.

FIG. 15 depicts the VRF determination table 158 of Embodiment 2 in its initial state. In its initial state, the VRF determination table 158 of Embodiment 2 differs from the VRF determination table 158 of Embodiment 1 depicted in FIG. 3 in that the second entry specifies the “Authentication VRF Forwarding Table” as the VRF forwarding table class; the third entry specifies the “First Enterprise VRF Forwarding Table” as the VRF forwarding table class; and the fourth entry specifies an interface number of “IF4”, a determination class of “Interface”, a MAC address of “−”, and a VRF forwarding table of “Second Enterprise VRF Forwarding Table”, respectively; the configuration is otherwise the same as in Embodiment 1.

As in Embodiment 1, the entries that appear in the VRF determination table 158 in the initial state are created on the basis of the interface role class table 15. Specifically, for the interface having the role class “Pre-authentication” (the second interface 112), a VRF forwarding table class of “Authentication VRF Forwarding Table” is created. For the interface having the role class “First Enterprise”, a VRF forwarding table class of “First Enterprise VRF Forwarding Table”, and for the interface having the role class “Second Enterprise”, a VRF forwarding table class of “Second Enterprise VRF Forwarding Table”, are respectively specified.

In the initial state, the terminal VRF forwarding table 156 of Embodiment 2 is identical to the terminal VRF forwarding table of Embodiment 1 depicted in FIG. 4, and as such requires no further description.

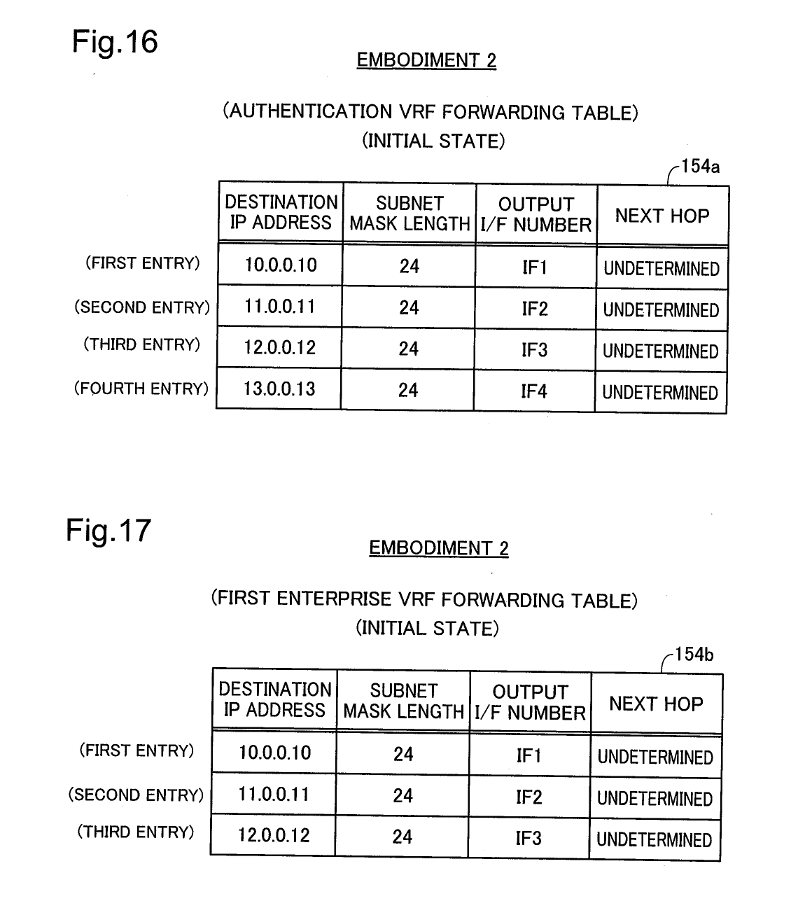

FIG. 16 is an illustration depicting the authentication VRF forwarding table 154a of Embodiment 2 in its initial state. The fields that appear in the authentication VRF forwarding table 154a are identical to the fields in the other VRF forwarding tables. In the initial state, the authentication VRF forwarding table 154a is identical to the post-authentication VRF forwarding table 154 of Embodiment 1 in the initial state depicted in FIG. 5, except that the fourth entry specifies a destination IP address of “13.0.0.13”, a subnet mask length of “24”, an output interface number of “IF4”, and a next hop of “Undetermined”. This fourth entry, like the first to third entries, is created by the control module 124 during initial configuration of the network system 10.

FIG. 17 is an illustration depicting the first enterprise VRF forwarding table 154b of Embodiment 2 in its initial state. In the initial state, the first enterprise VRF forwarding table 154b of Embodiment 2 is identical to the post-authentication VRF forwarding table 154 of Embodiment 1 in the initial state depicted in FIG. 5. Specifically, in the initial state, only entries describing the IP address of the interface connected to the user network 170 (the first interface 111), the IP address of the interface connected to the authentication network 190 (the second interface 112), and the IP address of the interface connected to the first enterprise network 180a (the third interface 113) are specified as destination IP addresses.

These initial entries are created by the routing control module 124 during initial configuration of the network system 10a. Specifically, for the interfaces whose role classes in the interface role class table 152 are “Terminal Targeted for Authentication”, “Pre-authentication”, and “First Enterprise”, there are created entries in which values for the Destination IP Address field, the Subnet Mask Length field, and the Output Interface Number field are set on the basis of the respective IP address, subnet mask, and interface number settings for these interfaces, and the Next Hop field is set to “Undetermined”.

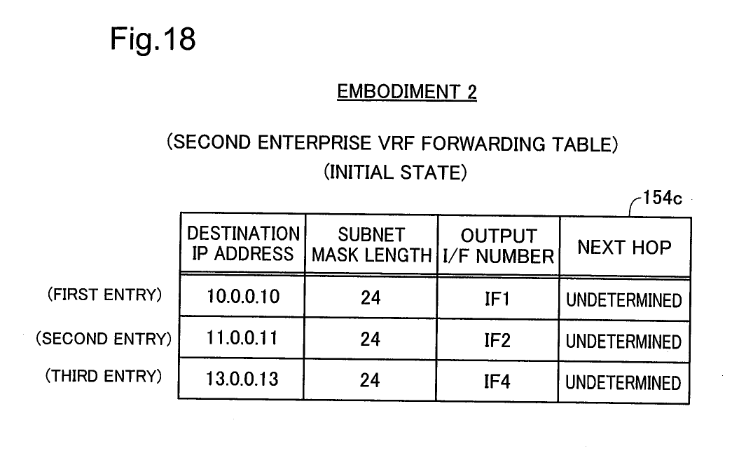

FIG. 18 is an illustration depicting the second enterprise VRF forwarding table 154c of Embodiment 2 in its initial state. In the initial state, the second enterprise VRF forwarding table 154c of Embodiment 2 differs from the first enterprise VRF forwarding table 154b in the initial state depicted in FIG. 17 in that the third entry specifies a destination IP address of “13.0.0.13”, a subnet mask length of “24”, an output interface number of “IF4”, and a next hop of “Undetermined”; the configuration is otherwise identical to the first enterprise VRF forwarding table 154b. As in the first enterprise VRF forwarding table 154b, these initial entries are created by the control module 124 during initial configuration of the network system 10a.

In the present embodiment, the first enterprise network 180a and the second enterprise network 180b correspond to the third networks recited in the claims. The authentication VRF forwarding table 154a corresponds to the third forwarding route table recited in the claims, and the first enterprise VRF forwarding table 154b and the second enterprise VRF forwarding table 154c to the second forwarding route table recited in the claims, respectively.

### B2. Overview of Forwarding Route Changes Before/After Successful Authentication

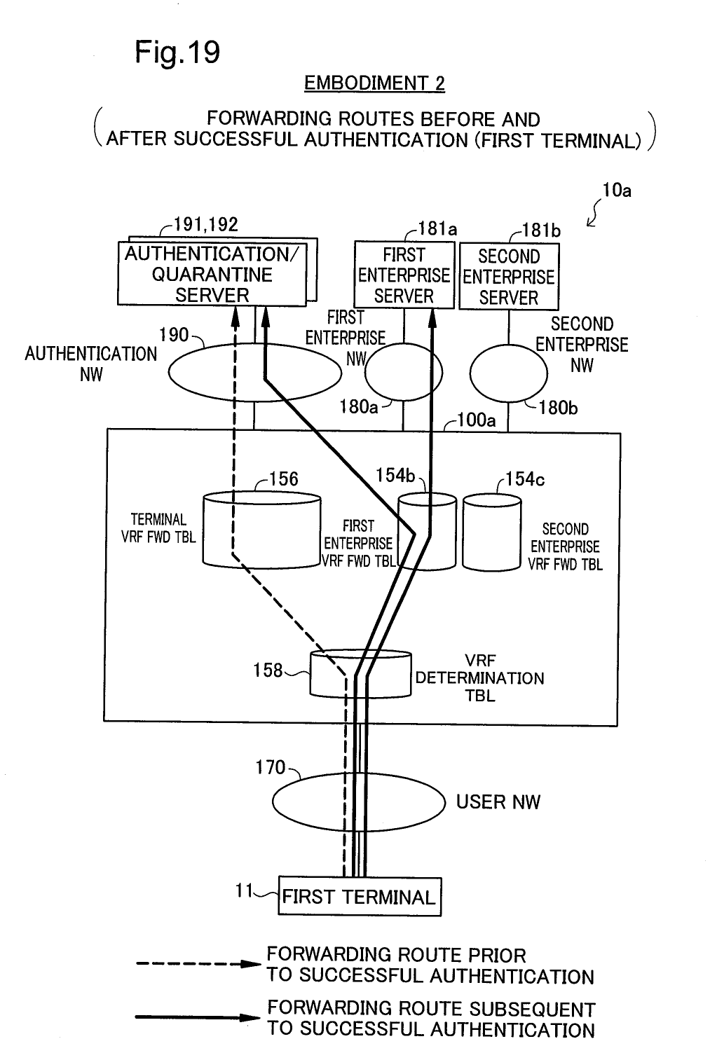

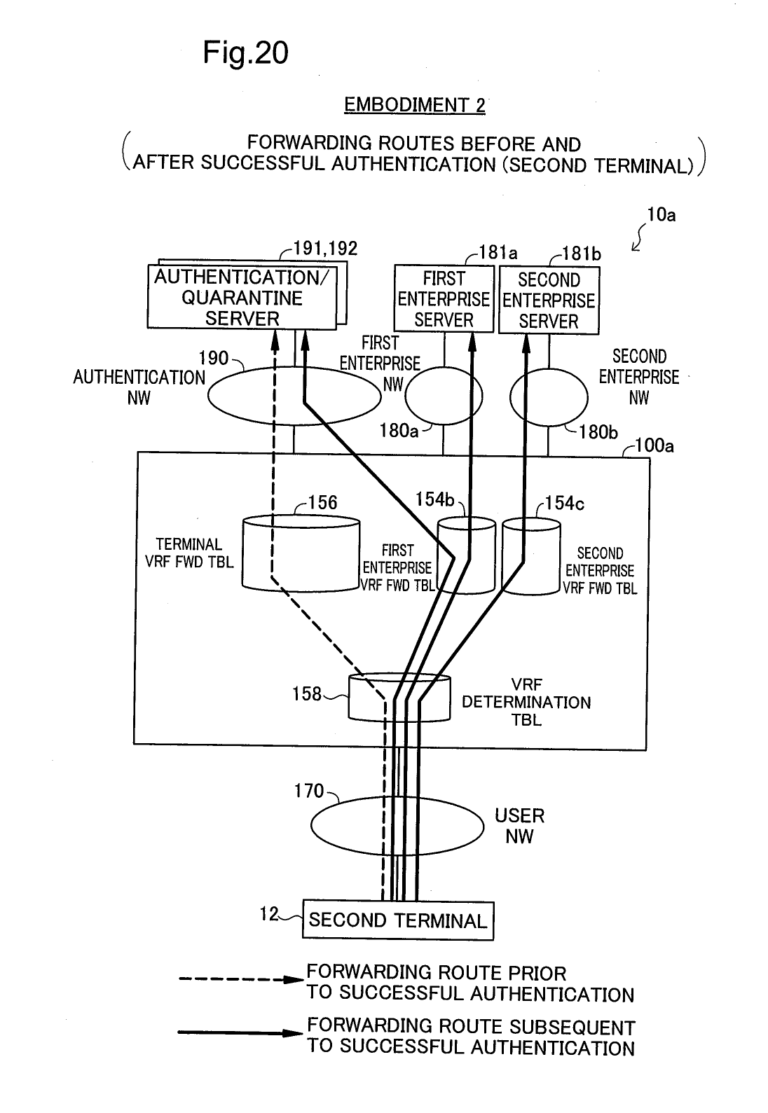

FIG. 19 is an illustration depicting in model form forwarding routes before and after successful authentication of the first terminal 11 in Embodiment 2. FIG. 20 is an illustration depicting in model form forwarding routing before and after successful authentication of the second terminal 12 in Embodiment 2.

In the network system 10a of Embodiment 2, with the tables having the initial settings described above, a VRF determination table 158 entry addition process and a packet forwarding process, discussed later, are carried out to produce a configuration whereby, prior to successful authentication both terminals are able to access the authentication network 190 only, whereas subsequent to successful authentication the individual terminals 11, 12 are provided access to the networks (servers) to which they have access permissions.

As depicted in FIG. 19, prior to successful authentication, a packet from the first terminal 11 is forwarded to the authentication server 191 and the quarantine server 192 along a forwarding route retrieved from the terminal VRF forwarding table 156. Subsequent to successful authentication, packets from the first terminal 11 are forwarded to the first enterprise server 181a along a forwarding route retrieved from the first enterprise VRF forwarding table 154b. Also, subsequent to successful authentication, packets from the first terminal 11 are forwarded to the authentication server 191 and the quarantine server 192 along a forwarding route retrieved from the first enterprise VRF forwarding table 154b. The configuration is such that packets from the first terminal 11 are not forwarded to the second enterprise server 181b.

As depicted in FIG. 20, prior to successful authentication, a packet from the second terminal 12 is forwarded to the authentication server 191 and the quarantine server 192 along a forwarding route retrieved from the terminal VRF forwarding table 156. Subsequent to successful authentication, packets from the second terminal 12 are forwarded to the first enterprise server 181a along a forwarding route retrieved from the first enterprise VRF forwarding table 154b. Subsequent to successful authentication, packets from the second terminal 12 are also forwarded to the second enterprise server 181b along a forwarding route retrieved from the second enterprise VRF forwarding table 154c. Also, subsequent to successful authentication, packets from the second terminal 12 are forwarded to the authentication server 191 and the quarantine server 192 along a forwarding route retrieved from the first enterprise VRF forwarding table 154b.

### B3. Operation during Terminal Authentication

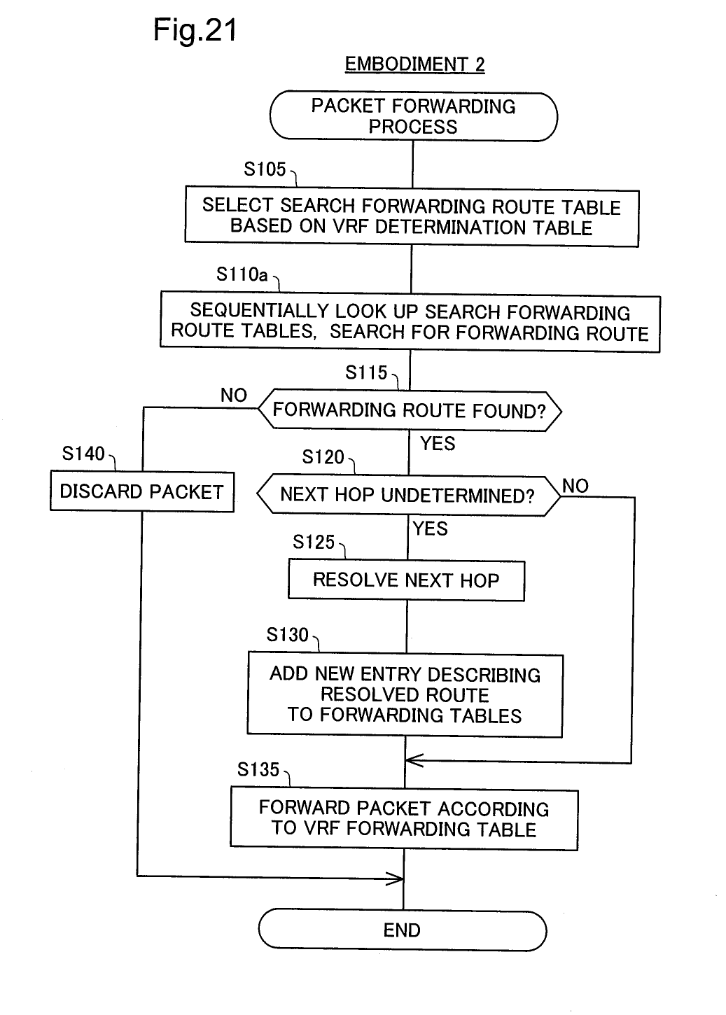

FIG. 21 is a flowchart depicting the procedure of the packet forwarding process in Embodiment 2. The packet forwarding process of Embodiment 2 differs from the packet forwarding process of Embodiment 1 (FIG. 7) in that Step S110 is replaced by Step S110a, but the procedure is otherwise the same as Embodiment 1. In Embodiment 2, setup of multiple VRF forwarding tables as VRF forwarding classes in the VRF determination table 158 is permitted. Consequently, in Step S105, multiple VRF forwarding tables may be selected as search VRF forwarding tables for arriving packets. In Step S110a, during the search for a forwarding route, lookup in the multiple VRF forwarding tables takes place in sequential fashion.

As will be discussed later, during terminal authentication, in Step S105 only the terminal VRF forwarding table 156 is selected as the search VRF forwarding table, so operation during terminal authentication (the result of executing Step S110a) is the same as in Embodiment 1.

Here, Embodiment 2 differs from Embodiment 1 in terms of the information of which the authentication process module 122 is notified by the authentication server 191 during successful authentication. Specifically, in the event of successful authentication and quarantine, in addition to notification of successful authentication (authentication and quarantine), the authentication server 191 also notifies the authentication process module 122 of information regarding network access permissions granted to successfully authenticated terminals. Specifically, in the case of successful authentication of the first terminal 11, the authentication server 191 looks up in the access permissions table 193 shown in FIG. 13, and notifies the authentication process module 122 of “First Enterprise Network” network access permission, in addition to notification of successful authentication. In the case of successful authentication of the second terminal 12, the authentication server 191 looks up in the access permissions table 193 and notifies the authentication process module 122 of “First Enterprise Network and Second Enterprise Network” network access permissions in addition to notification of successful authentication. The authentication process module 122 then notifies the VRF determination control module 128 of successful authentication and of the network access permissions information.

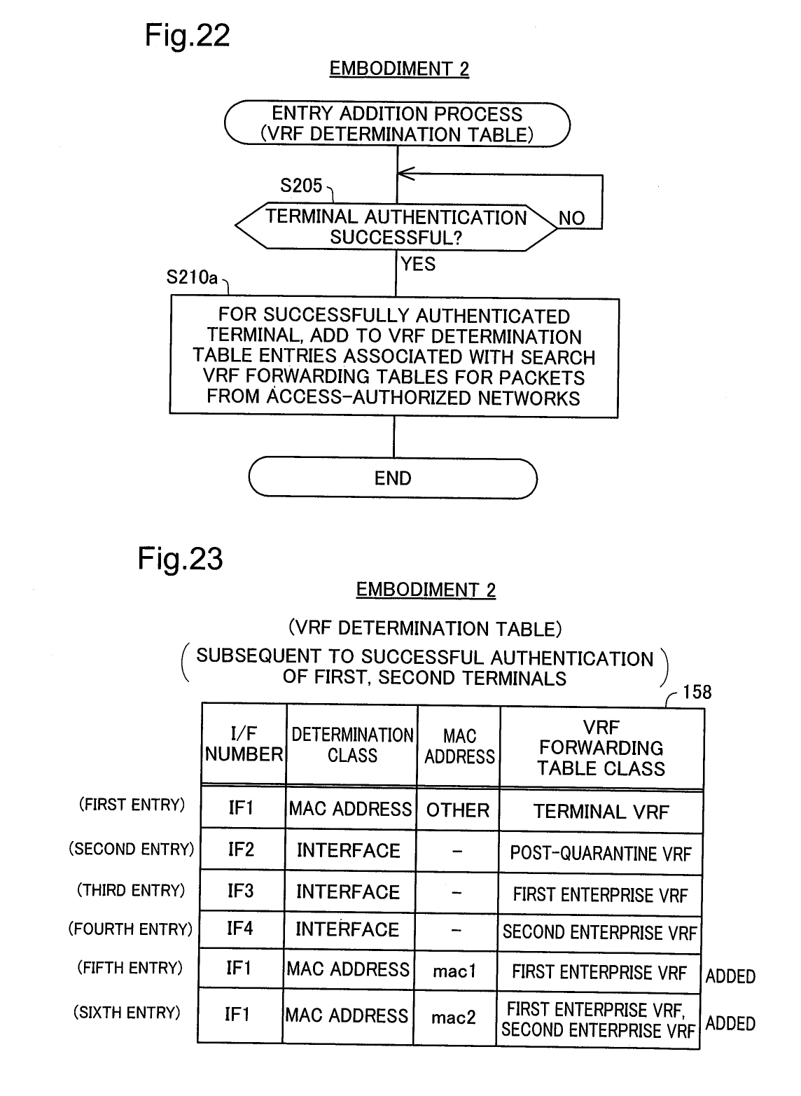

FIG. 22 is a flowchart depicting the procedure of the process for adding an entry to the VRF determination table in Embodiment 2. The VRF determination table entry addition process of Embodiment 2 differs from the VRF determination table entry addition process of Embodiment 1 shown in FIG. 10 in that Step S210 is replaced by Step S210a, but the procedure is otherwise identical to Embodiment 1. After executing Step S205, the VRF determination control module 128 adds to the VRF determination table 158 an entry for the successfully authenticated terminal, associating it with a search VRF forwarding table for packets from networks to which it has access permissions (Step S210a).

FIG. 23 is an illustration depicting the VRF determination table 158 after addition of entries for the first terminal 11 and the second terminal 12, subsequent to successful authentication of these two terminals 11, 12. The network to which the first terminal 11 has access permission is the first enterprise network 180a. The search VRF forwarding table for packets from the first enterprise network 180a is the first enterprise VRF forwarding table 154b (see the third entry in the VRF determination table 158). Accordingly, in the event of successful authentication of the first terminal 11, the VRF determination control module 128 adds to the VRF determination table 158 an entry specifying an interface number of “IF1”, a determination class of “MAC Address”, a MAC address of “mac1”, and a VRF forwarding table class of “First Enterprise VRF Forwarding Table” (fifth entry).

The networks to which the second terminal 12 has access permission are the first enterprise network 180a and the second enterprise network 180b. The search VRF forwarding table for packets from the first enterprise network 180a is the first enterprise VRF forwarding table 154b (see the third entry in the VRF determination table 158). The search VRF forwarding table for packets from the second enterprise network 180b is the second enterprise VRF forwarding table 154c (see the fourth entry in the VRF determination table 158). Accordingly, in the event of successful authentication of the second terminal 12, the VRF determination control module 128 adds to the VRF determination table 158 an entry specifying an interface number of “IF1”, a determination class of “MAC Address”, a MAC address of “mac2”, and VRF forwarding table classes of “First Enterprise VRF Forwarding Table, Second Enterprise VRF Forwarding Table” (sixth entry).

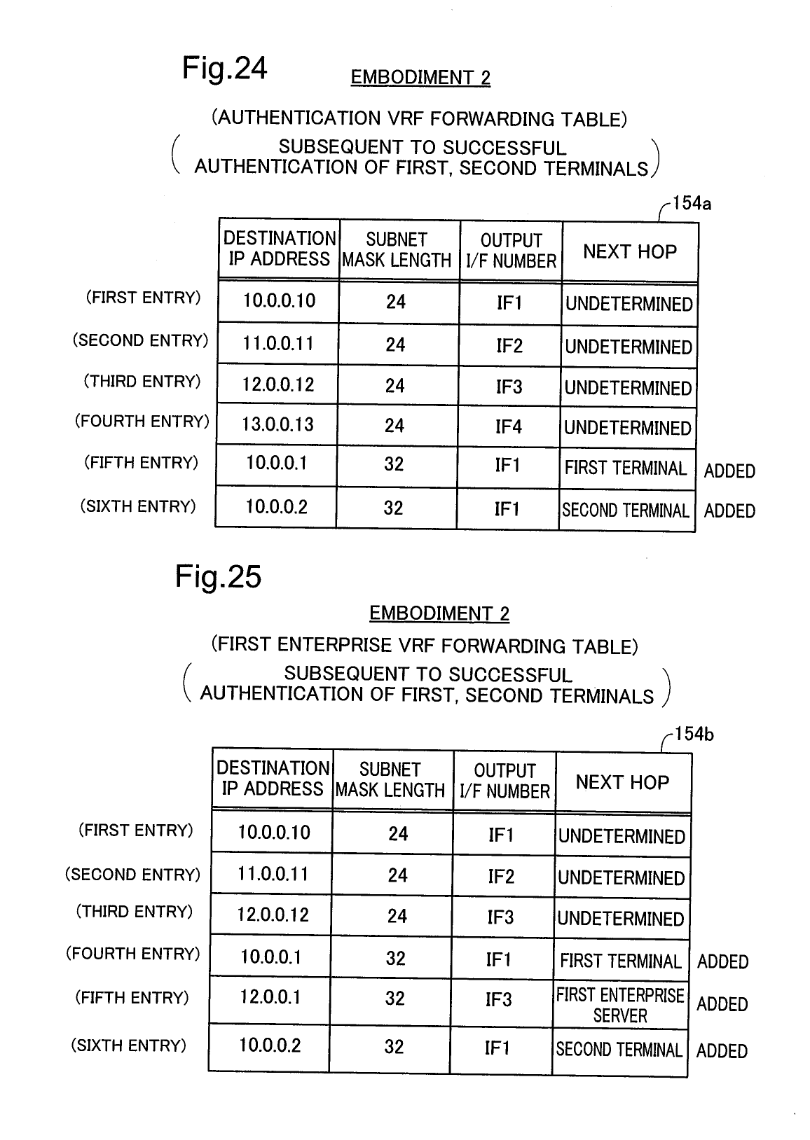

FIG. 24 is an illustration depicting the authentication VRF forwarding table 154a subsequent to successful authentication of the first terminal 11 and the second terminal 12. In the authentication operation for the two terminals 11, 12, the authentication server 191 and the quarantine server 192 transmit packets to these two terminals 11, 12. During this process, the next hop to each terminal 11, 12 is resolved, and the fifth and sixth entries are added.

### B4. Packet Forwarding Process After Successful Terminal Authentication

The description now turns to the packet forwarding process when a packet is transmitted from the first terminal 11 to the enterprise server 181 subsequent to successful authentication. In Step S105 shown in FIG. 21, on the basis of the fifth entry in the VRF determination table 158 shown in FIG. 23, the first enterprise VRF forwarding table 154b is selected as the search VRF forwarding table.

FIG. 25 is an illustration depicting the first enterprise VRF forwarding table 154b subsequent to successful authentication of the first terminal 11 and the second terminal 12. FIG. 25 shows the first enterprise VRF forwarding table 154b after both successful authentication and quarantine of the first terminal 11 and the second terminal 12, and subsequent access of the first enterprise server 181a by the first terminal 11 and the second terminal 12. If only the first terminal 11 has accessed the first enterprise server 181a but the second terminal 12 has not accessed the first enterprise server 181a, the fourth and fifth entries are added subsequent to the initial state depicted in FIG. 17. If the second terminal 12 subsequently accesses the first enterprise server 181a, the sixth entry is added.

As shown in FIG. 25, the third entry in the first enterprise VRF forwarding table 154b specifies the third interface 113 as the destination IP address. Consequently, this entry is found in Step S110a, whereupon the next hop to the first enterprise server 181a is resolved (Step S125), and a fifth entry is added (Step S130). Accordingly, packets are forwarded from the first terminal 11 to the first enterprise server 181a on the basis of this fifth entry in the first enterprise VRF forwarding table 154b (Step S135). Subsequently, a fourth entry is added during packet transfer from the first enterprise server 181a to the first terminal 11.

The first enterprise VRF forwarding table 154b shown in FIG. 25 also describes an entry specifying the second interface 112 (second entry) as a destination IP address in addition to the third interface 113. Consequently, subsequent to successful authentication, the first terminal 11 is able to access the authentication network 190 (the authentication server 191 and the quarantine server 192) in addition to the first enterprise network 180a (the first enterprise server 181a). On the other hand, the first enterprise VRF forwarding table 154b does not describe an entry specifying the fourth interface 114 as a destination IP address. Consequently, subsequent to successful authentication, the first terminal 11 is unable to access the second enterprise network 180b (the second enterprise server 181b).

The discussion now turns to the packet forwarding process when the first enterprise server 181a is accessed by the second terminal 12 subsequent to successful authentication. It is assumed that access of the first enterprise server 181a by the first terminal 11 described above has already taken place, that the next hop to the first enterprise server 181a has been resolved, and that the fifth entry is described in the first enterprise VRF forwarding table 154b.

In Step S105, on the basis of the sixth entry in the VRF determination table 158 shown in FIG. 23, the first enterprise VRF forwarding table 154b and the second enterprise VRF forwarding table 154c are selected as search VRF forwarding tables. In Step S110a, lookup in these two VRF forwarding tables 154a, 154b takes place in that order to search for the forwarding route. Here, because the first enterprise VRF forwarding table 154b (FIG. 25) describes an entry specifying the first enterprise server 181a as the next hop (the fifth entry), the forwarding route to the first enterprise server 181a is found without lookup in the second enterprise VRF forwarding table 154c. Consequently, packets are forwarded from the second terminal 12 to the first enterprise server 181a based on the fifth entry in the first enterprise VRF forwarding table 154b.

The discussion now turns to the packet forwarding process when the second enterprise server 181b is accessed by the second terminal 12 subsequent to successful authentication.

In Step S105, in the same way as in the case of accessing the first enterprise server 181a described above, the first enterprise VRF forwarding table 154b and the second enterprise VRF forwarding table 154c are selected as search VRF forwarding tables. In Step S110a, these two VRF forwarding tables 154a, 154b are looked up in that order to search for the forwarding route.

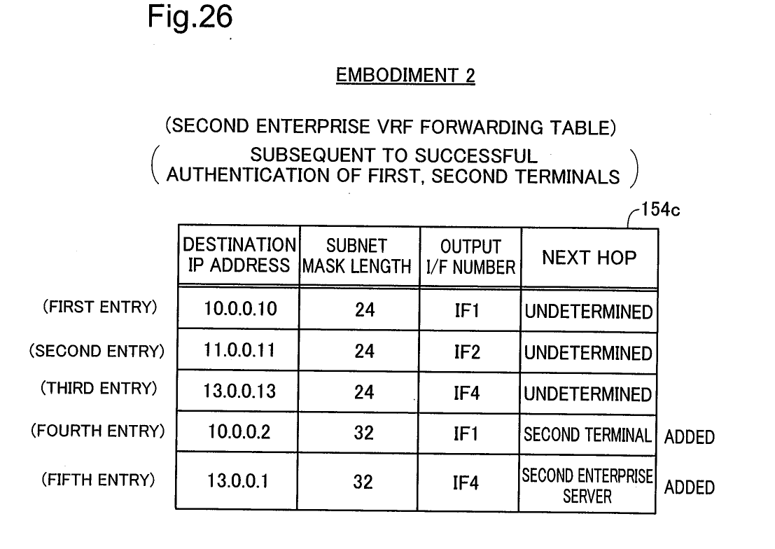

FIG. 26 is an illustration depicting the second enterprise VRF forwarding table 154c subsequent to successful authentication of the first terminal 11 and the second terminal 12. FIG. 26 shows the second enterprise VRF forwarding table 154c after both successful authentication and quarantine of the first terminal 11 and the second terminal 12, and subsequent access of the second enterprise server 181b by the second terminal 12. The fourth and fifth entries are not described when the second terminal 12 initially accesses the second enterprise server 181b.

As shown in FIGS. 18 and 26, the second enterprise VRF forwarding table 154c describes an entry specifying the fourth interface 114 as the destination IP address (third entry). Meanwhile, the first enterprise VRF forwarding table 154b shown in FIGS. 17 and 25 does not describe an entry specifying the fourth interface 114. Consequently, in Step S110a, when lookup in the first enterprise VRF forwarding table 154b and the second enterprise VRF forwarding table 154c takes place in that order, the third entry in the second enterprise VRF forwarding table 154c is found. The next hop to the second enterprise server is then resolved (Step S125), and a fifth entry is added to the second enterprise VRF forwarding table 154c. Consequently, packets are forwarded from the second terminal 12 to the second enterprise server 181b based on this fifth entry (Step S135).

As mentioned above, the first enterprise VRF forwarding table 154b shown in FIG. 25 describes an entry specifying the second interface 114 as the destination IP address (second entry). Consequently, subsequent to successful authentication, the second terminal 12, like the first terminal 11, is able to access the authentication network 190 (the authentication server 191 and the quarantine server 192).

The network system 10a of Embodiment 2 described above affords the same effects as the network system 10 of Embodiment 1. Additionally, it employs an arrangement whereby the first enterprise VRF forwarding table 154b describes an entry specifying the third interface 113 as the destination IP address, but does not describe an entry specifying the fourth interface 114; whereas the second enterprise VRF forwarding table 154c describes an entry specifying the fourth interface 114 as the destination IP address, but does not describe an entry specifying the third interface 113. The VRF determination table 158 employs an arrangement describing an entry specifying the first enterprise VRF forwarding table 154b as the search VRF forwarding table for packets from the first terminal 11, and describes an entry specifying the first and second enterprise VRF forwarding table 154c as search VRF forwarding tables for packets from the second terminal 12. Through such arrangements, the first terminal 11 is able to access the first enterprise network 180 (the first enterprise server 181a), but not able to access the second enterprise network 180 (the second enterprise server 181b). The second terminal 12 is able to access both the first enterprise network 180 (the first enterprise server 181a) and the second enterprise network 180 (the second enterprise server 181b).

Additionally, because the first enterprise VRF forwarding table 154b describes an entry specifying the second interface 112 as the destination IP address, subsequent to successful authentication, both the first terminal 11 and the second terminal 12 are able to access the authentication network 190 (the authentication server 191 and the quarantine server 192).

### C. Embodiment 3

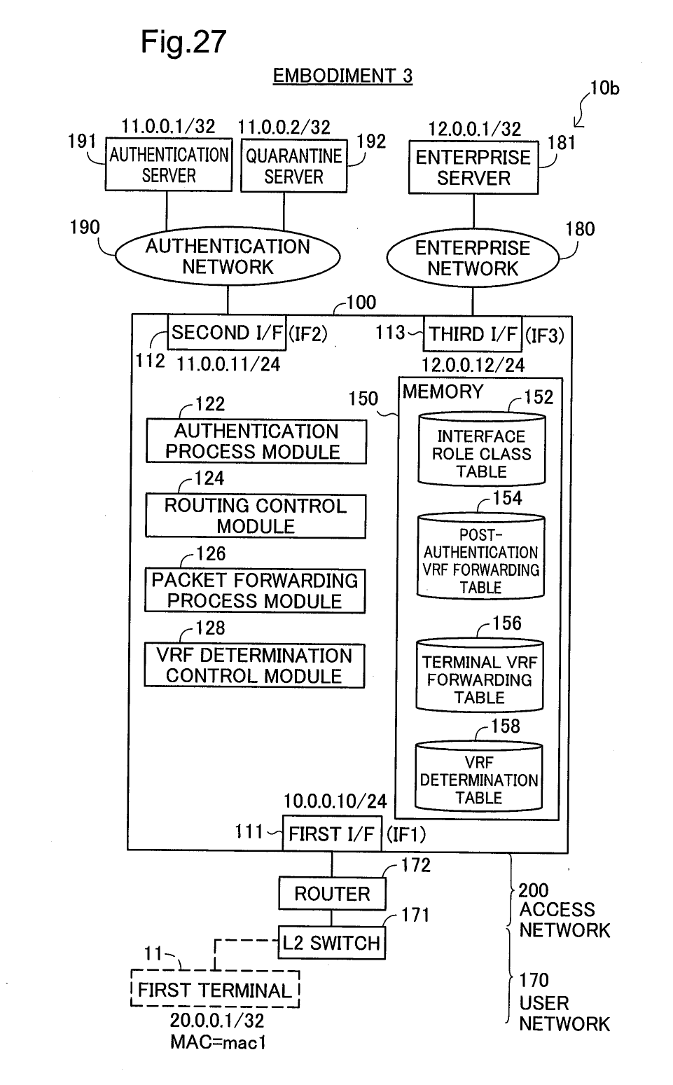

FIG. 27 is an illustration depicting a configuration of a network system according to a third embodiment of the invention. The network system 10b of Embodiment 3 differs from Embodiment 1 in that a router 172 and an access network 200 are provided, but the configuration is otherwise the same as Embodiment 1.

The router 172 connects to a Layer 2 switch 171 and to the first interface 111 of the packet forwarding device 100, and connects the user network 180 and the access network 200 in Layer 3. The access network 200 is a Layer 3 network (VLAN) provided between the router 172 and the first interface 111. The first terminal 11 is pre-assigned the IP address “20.0.0.1/32”.

Where the first terminal 11 and the first interface 111 are connected via the router 172 in this way, packets (Layer 2 frames) arriving at the first interface 11 from the router 172 have as the sending address (MAC address) a MAC address assigned to a port of the router 172. Consequently, in Step S105 of the packet forwarding process it is not possible to determine the correct sender of the packet on the basis of the sending MAC address. Embodiment 3 features a design whereby the sender of a packet can be determined on the basis of the sending MAC address.

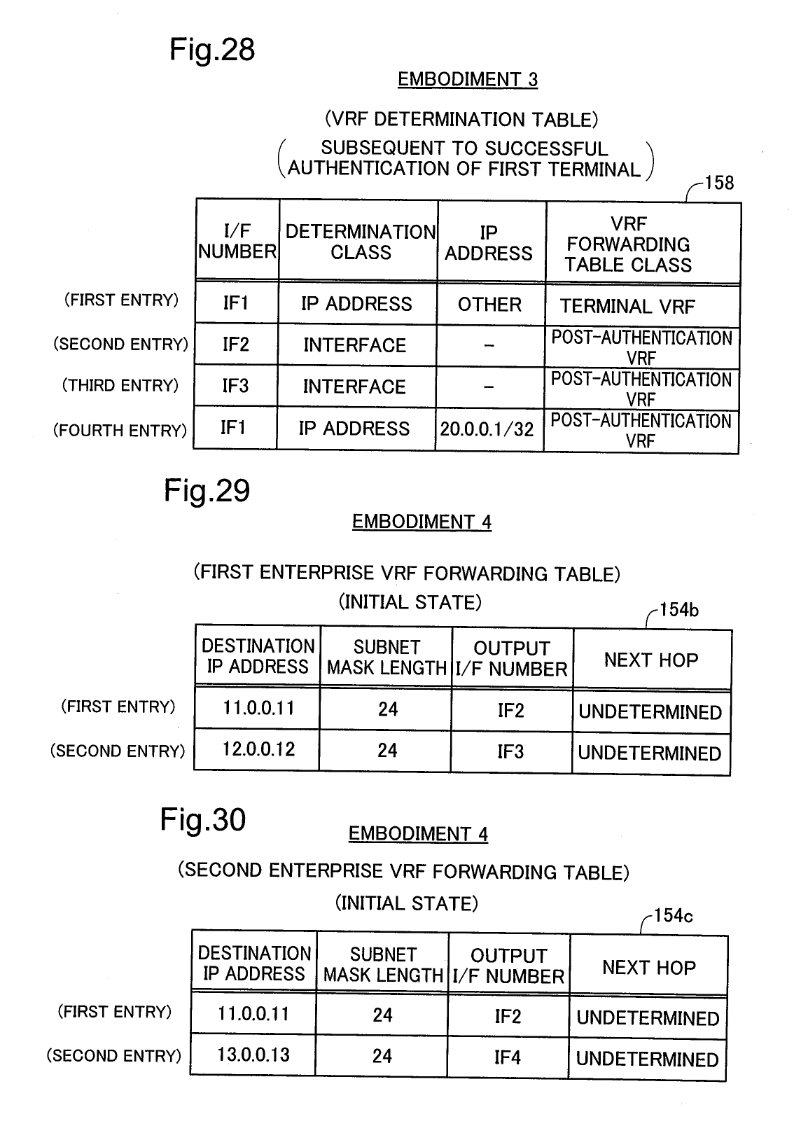

FIG. 28 is an illustration depicting the VRF determination table 158 in Embodiment 3. FIG. 28 shows the VRF determination table 158 subsequent to both successful authentication and quarantine of the first terminal 11. The VRF determination table 158 of Embodiment 3 differs from the VRF determination table of Embodiment 1 in that the MAC Address field is replaced by an IP Address field, but is otherwise identical to Embodiment 1.

In FIG. 28, the fourth entry is an entry added subsequent to successful authentication of the first terminal 11. This fourth entry specifies an interface value of “IF1”, a determination class of “IP Address”, an IP address of “20.0.0.1/32”, and a VRF forwarding table class of “Post-authentication VRF Forwarding Table”. Consequently, when packets are received from the first terminal 11 subsequent to successful authentication, because the IP address of the sender of the packets is “20.0.0.1/32”, the post-authentication VRF forwarding table is selected as the search VRF forwarding table on the basis of the fourth entry.

The network system 10b of Embodiment 3 described above affords effects comparable to those of the network system 10 of Embodiment 1. Additionally, in the VRF determination table 158, the entry for selecting the search VRF forwarding table for packets transmitted from the first terminal 11 specifies a determination class of “IP Address” and an IP address of “20.0.0.1/32”, whereby the sender of a packet arriving at the packet forwarding device 100 can be determined from the IP address. Consequently, the sender of the packet can be correctly determined even in instances where the network to which the first terminal 11 belongs and the network to which the first interface 111 are different.

### D. Embodiment 4

The network system of Embodiment 4 differs from the network system 10a of Embodiment 2 in that the first enterprise VRF forwarding table 154b and the second enterprise VRF forwarding table 154c in their initial state contain no entry specifying the first interface 111 (the user network 170) as a destination IP address, and a process to add entries to the VRF forwarding table is carried out in addition to adding entries to the VRF determination table 158; the configuration is otherwise identical to Embodiment 2.

The network system of Embodiment 4 is configured so that terminals accessible by the first enterprise server 181a and the second enterprise server 181b are limited to the first terminal 11 and the second terminal, 12, with access to other terminals (not shown) belonging to the user network 170 being restricted.

FIG. 29 is an illustration depicting the initial state of the first enterprise VRF forwarding table 154b of Embodiment 4. FIG. 30 is an illustration depicting the initial state of the second enterprise VRF forwarding table 154c of Embodiment 4. As shown in FIG. 29, in contrast to Embodiment 2, in the initial state the first enterprise VRF forwarding table 154b of Embodiment 4 does not contain an entry specifying the first interface (10.0.0.10/24) as a destination IP address. Likewise, as shown in FIG. 30, in contrast to Embodiment 2, in the initial state the second enterprise VRF forwarding table 154c does not contain an entry specifying the first interface (10.0.0.10/24) as a destination IP address.

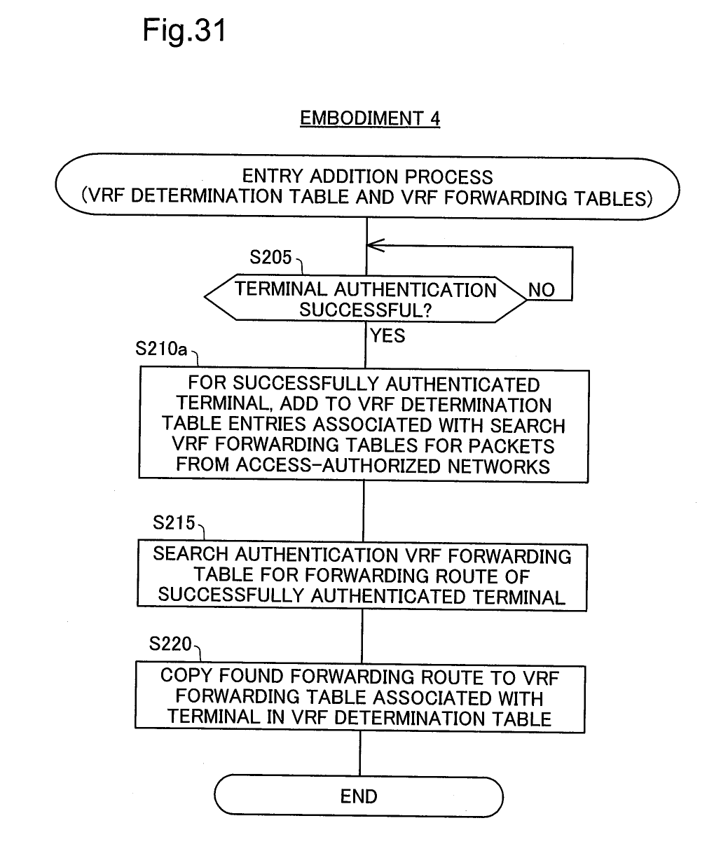

FIG. 31 is a flowchart depicting the procedure of the process for adding entries to the VRF determination table 158 and the VRF forwarding tables in Embodiment 4. Step S205 and Step S210a are identical with the VRF determination table entry addition process (FIG. 22) of Embodiment 2. Once a terminal is successfully authenticated (Step S205: YES) and an entry for the successfully authenticated terminal is added to the VRF determination table 158 (Step S210a), the routing control module 124 searches the authentication VRF forwarding table 154a for a forwarding route to the successfully authenticated terminal (Step S215).

As shown in FIG. 24, subsequent to successful authentication of the first terminal 11 and the second terminal 12, the authentication VRF forwarding table 154a describes an entry indicating the forwarding route to the first terminal 11 (fifth entry) and an entry indicating the forwarding route to the second terminal 12 (sixth entry). Consequently, if Step S215 is executed subsequent to successful authentication of the first terminal 11 and the second terminal 12, the fifth or sixth entry in the authentication VRF forwarding table is found.

Once the forwarding route to a successfully authenticated terminal is found, the routing control module 124 copies the found forwarding route to the VRF forwarding table that is associated with the terminal in the VRF determination table 158 (Step S220).

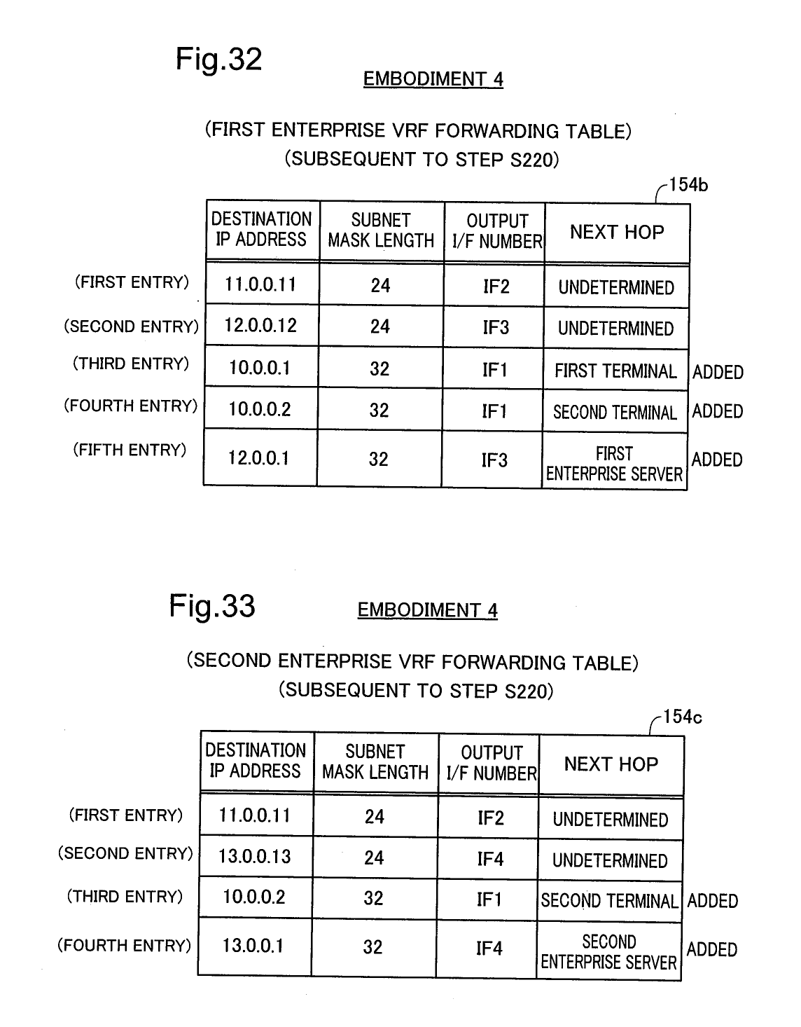

FIG. 32 is an illustration depicting the first enterprise VRF forwarding table 154b subsequent to execution of Step S220. FIG. 33 is an illustration depicting the second enterprise VRF forwarding table 154c subsequent to execution of Step S220.

As was shown in FIG. 23, in the VRF determination table 158 subsequent to successful authentication of the first terminal 11 and the second terminal 12, the first enterprise VRF forwarding table 154b is associated with the first terminal 11. The first enterprise VRF forwarding table 154b and the second enterprise VRF forwarding table 154c are associated with the second terminal 12. Consequently, once Step S22 is executed, third and fourth entries are added to the first enterprise VRF forwarding table 154b as shown in FIG. 32, and a third entry is added to the second enterprise VRF forwarding table 154c as shown in FIG. 33.

Thus, for packets from the first enterprise server 181a destined for the first terminal 11, the packets are forwarded on the basis of the third entry shown in FIG. 32. For packets from the first enterprise server 181a destined for the second terminal 12, the packets are forwarded on the basis of the fourth entry shown in FIG. 32. For packets from the first enterprise server 181a destined for other terminals (not shown) belonging to the user network 170, because the first enterprise VRF forwarding table 154b contains no entry specifying the first interface 111 (10.0.0.10/34) as a destination IP address, ARP resolution is not possible, and the packets are discarded because no forwarding route is found.

For packets from the second enterprise server 181b destined for the second terminal 12, the packets are forwarded on the basis of the third entry of the second enterprise VRF forwarding table 154c shown in FIG. 33. For packets from the second enterprise server 181b destined for other terminals (not shown) belonging to the user network 170, because the second enterprise VRF forwarding table 154c contains no entry specifying the first interface 111 (10.0.0.10/34) as a destination IP address, ARP resolution is not possible, and the packets are discarded because no forwarding route is found.

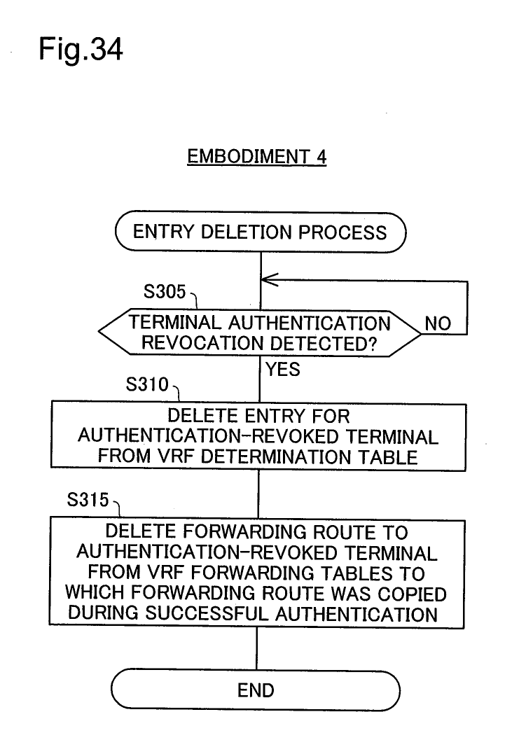

FIG. 34 is a flowchart depicting the procedure of the entry deletion process of Embodiment 4. The entry deletion process of Embodiment 4 differs from the VRF determination table entry deletion process of Embodiments 1 and 2 (FIG. 12) in that an additional Step S315 is provided, but the procedure is otherwise identical to the VRF determination table entry deletion process.

After the entry for a terminal whose authentication was revoked is deleted from the VRF determination table 158 in Step S310, the routing control module 124 deletes the forwarding route to the authentication-revoked terminal from the VRF forwarding tables (Step S315).

Specifically, if authentication is revoked for the two terminals 11 and 12, the routing control module 124 deletes the third and fourth entries from the first enterprise VRF forwarding table 154b shown in FIG. 32, and deletes the third entry from the second enterprise VRF forwarding table 154c shown in FIG. 33. These entries for deletion are selected on the basis of information (IP address etc.) relating to the authentication-revoked terminals that is advertised by the authentication process module 122.

In the present embodiment, the third and fourth entries shown in FIG. 32 and the third entry shown in FIG. 33 correspond to the terminal forwarding route information recited in the claims.

The network system of Embodiment 4 described above affords effects comparable to those of the network system 10 of Embodiment 1. Additionally, in the network system of Embodiment 4, the first enterprise server 181a and the second enterprise server 181b in their initial state do not describe an entry (forwarding route) specifying the first interface 111 (10.0.0.10/24) as a destination IP address, and only forwarding routes for successfully authenticated terminals are copied from the authentication VRF forwarding table 154a. Consequently, forwarding of packets from the first enterprise server 181a and the second enterprise server 181b to the first terminal 11 and the second terminal 12 is possible, while forwarding of packets from these two enterprise servers 181a, 181b to other terminals belonging to the user network 170 (or to the terminals 11, 12 prior to successful authentication) is restricted. Thus, security can be enhanced in communications directed to the user network 170 from the two enterprise servers 181a, 181b.

Additionally, because forwarding routes for successfully authenticated terminals are copied from the authentication VRF forwarding table 154a, when packets are initially transmitted from the first enterprise server 181a and the second enterprise server 181b to the first terminal 11 and the second terminal 12, there is no need for the next hop to be resolved a second time. Consequently, subsequent to successful authentication, the first terminal 11 and the second terminal 12 can promptly carry out communication with the first enterprise server 181a or the second enterprise server 181b.

### E. Embodiment 5

### E1. System Configuration

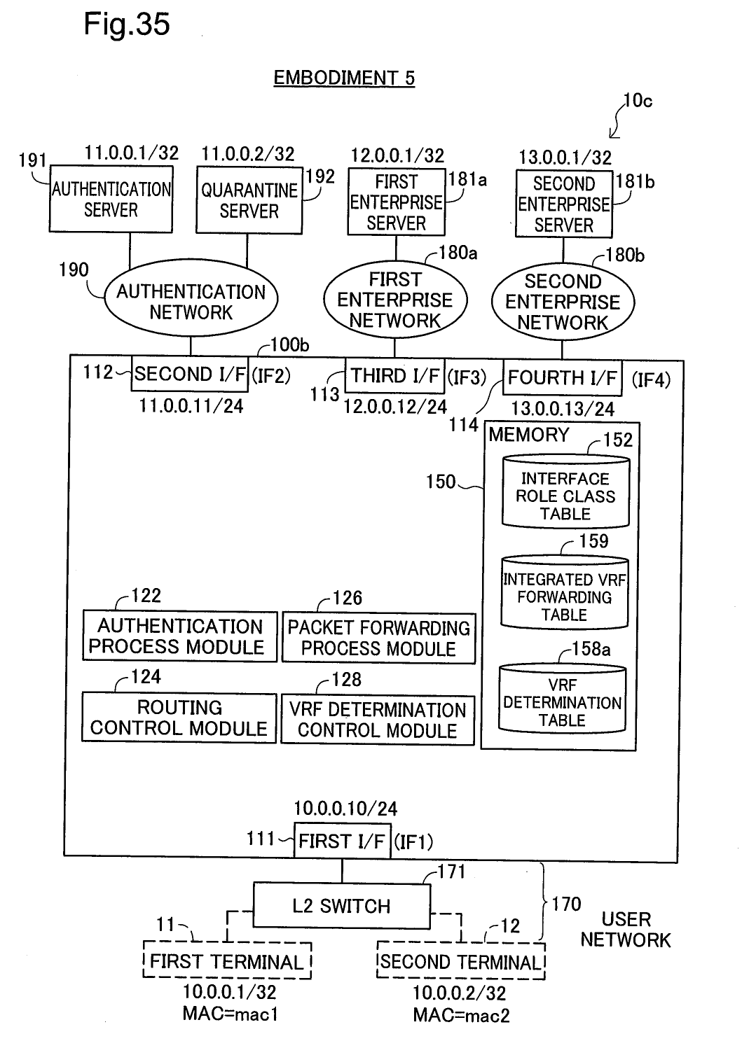

FIG. 35 is an illustration depicting a configuration of a network system 10a according to a fifth embodiment. The network system 10c of Embodiment 5 differs from the network system 10a of Embodiment 2 (FIG. 13) in that the packet forwarding device 100b is provided with an integrated VRF forwarding table 159 in place of the authentication VRF forwarding table 154a, the first enterprise VRF forwarding table 154b, the second enterprise VRF forwarding table 154c, and the terminal VRF forwarding table 156; and in terms of the settings contained in the VRF determination table 158, but the configuration is otherwise identical to Embodiment 2.

In Embodiment 5, forwarding routes to the interfaces 111 to 114 of the packet forwarding device 100b, to the terminals 11, 12, and to the servers 191, 192, 181a, 181b are specified as entries in the integrated VRF forwarding table 159, thereby avoiding duplicate descriptions of the same forwarding route in multiple tables and reducing the capacity required in the memory 150 of the packet forwarding device 100b. Also, because the network system 10c of Embodiment 5 is provided with the integrated VRF forwarding table 159 as the only table describing forwarding routes, it lacks so-called VRF functionality. However, virtual VRF functionality is achieved in the integrated VRF forwarding table 159 by varying the range of entries for lookup during forwarding route searches, according to the packet sender.

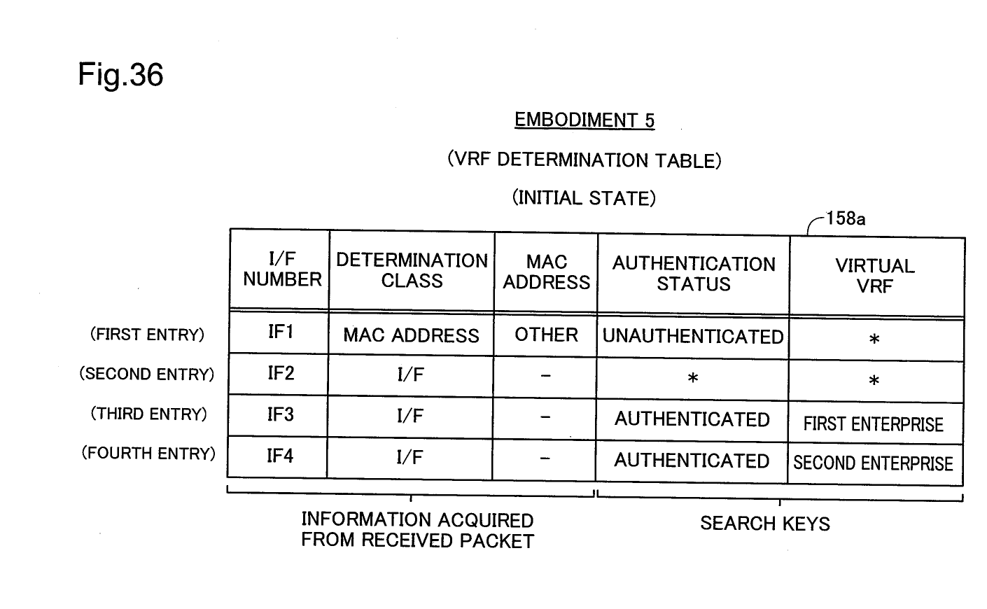

FIG. 36 is an illustration depicting the VRF determination table 158a of Embodiment 5. In FIG. 36, the VHF determination table 158a is shown in the initial state. This VRF determination table 158a differs from the VRF determination table 158 of Embodiment 2 depicted in FIG. 15 in that the VRF Forwarding Table Class field is replaced by an Authentication Status field, but the configuration is otherwise the same as Embodiment 2.

The Authentication Status field indicates whether successful authentication (authentication and quarantine) has taken place. A value of “Unauthenticated” in this Authentication Status field indicates pre-successful authentication status, while a value of “Authenticated” indicates post-successful authentication status. A value of “*” in the Authentication Status field indicates that either pre-successful authentication status or post-successful authentication status is acceptable.

The Virtual VHF field specifies virtual VRF forwarding tables to be used to carry out virtual VRF functionality. A value of “First Enterprise” in this Virtual VRF field indicates a virtual first enterprise VRF forwarding table (first enterprise virtual VRF forwarding table), and a value of “Second Enterprise” indicates a virtual second enterprise VRF forwarding table (second enterprise virtual VRF forwarding table). A value of “*” in this Virtual VRF field indicates that either the first enterprise virtual VRF forwarding table or the second enterprise virtual VRF forwarding table is acceptable. The first enterprise virtual VRF forwarding table refers to a virtual VRF forwarding table used in searches for packet forwarding routes from the first enterprise network 180a, and the second enterprise virtual VRF forwarding table refers to a virtual VRF forwarding table used in searches for packet forwarding routes from the second enterprise network 180b.

As shown in FIG. 36, in the initial state the VRF determination table 158a, like the VRF determination table 158 shown in FIG. 15, specifies first through fourth entries. The Interface Number, Determination Class, and MAC Address fields in the entries depicted in FIG. 36 have the same setting values as the VRF determination table 158 shown in FIG. 15, and are therefore not discussed. With the VRF determination table 158a in the initial state, in the first entry the Authentication Status field is set to “Unauthenticated” and the Virtual VRF field is set to “*”. In the second entry, Authentication Status is set to “*” and the Virtual VRF field to “*”; in the third entry the Authentication Status field is set to “Authenticated” and the Virtual VRF field is set to “First Enterprise”; and in the fourth entry the Authentication Status field is set to “Authenticated” and the Virtual VRF field is set to “Second Enterprise”, respectively.

These four entries are created by the VRF determination control module 128 during initial configuration of the network system 10c. Specifically, the VRF determination control module 128 looks up in the interface role class table 152 shown in FIG. 14 and acquires the role classes that have been established for the interfaces 111 to 113. Next, for the interface whose role class is “Terminal Targeted for Authentication” (the first interface 111), the VRF determination control module 128 adds to the VRF determination table 158a an entry specifying authentication status of “Unauthenticated” and a virtual VRF of “*”. For the interface whose role class is “Pre-authentication” (the second interface 112), the VRF determination control module 128 adds to the VRF determination table 158a an entry specifying authentication status and a virtual VRF of “*”. For the interface whose role class is “First Enterprise” (the third interface 113), the VRF determination control module 128 adds to the VRF determination table 158a an entry specifying authentication status of “Authenticated” and a virtual VRF of “First Enterprise”. For the interface whose role class is “Second Enterprise” (the fourth interface 114), the VRF determination control module 128 adds to the VRF determination table 158a an entry specifying authentication status of “Authenticated” and a virtual VRF of “Second Enterprise”.

The VRF determination table 158a of Embodiment 2 discussed above was used to select a VRF forwarding table class value (i.e. a search VRF forwarding table) for received packets on the basis of interface number, determination class, and MAC address. The VRF determination table 158a of Embodiment 5, on the other hand, is used to decide on authentication status and on a virtual VRF forwarding table used to search for a forwarding route (hereinafter termed a “search virtual VRF forwarding table”, on the basis of interface number, determination class, and MAC address.

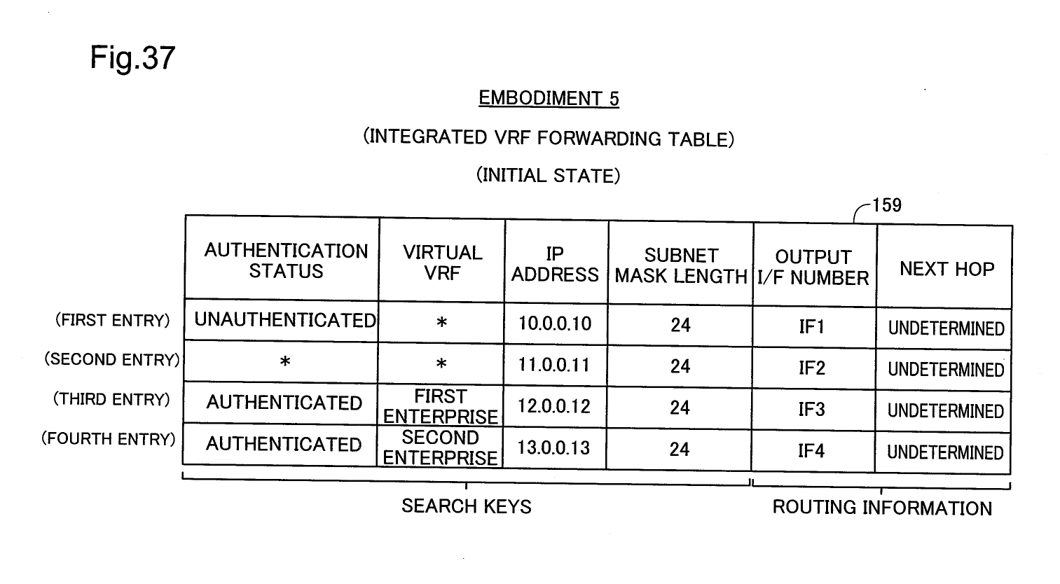

FIG. 37 is an illustration depicting the integrated VRF forwarding table 159 of Embodiment 5. FIG. 37 shows the integrated VRF forwarding table 159 in the initial state. This integrated VRF forwarding table 159 differs from the VRF forwarding tables 154a to 154c of Embodiment 2 in that it is provided with an Authentication Status field and a Virtual VRF field, but is otherwise identical in configuration to Embodiment 2.

The Authentication Status field and the Virtual VRF field of the integrated VRF forwarding table 159 are identical in meaning to the Authentication Status field and the Virtual VRF field of the VRF determination table 158a shown in FIG. 36.

As shown in FIG. 37, the integrated VRF forwarding table 159 in its initial state contains four entries (first to fourth entries). The first entry specifies an authentication status of “Unauthenticated”, a virtual VRF field of an IP address of “10.0.0.10”, a subnet mask length of “24”, an output interface number of “IF1”, and a next hop field of “Undetermined”, respectively. The second entry specifies an authentication status of “*”, a virtual VRF field of “*”, an IP address of “11.0.0.11”, a subnet mask length of “24”, an output interface number of “IF2”, and a next hop field of “Undetermined”, respectively. The third entry specifies an authentication status of “Authenticated”, a virtual VRF field of “First Enterprise”, an IP address of “12.0.0.12”, a subnet mask length of “24”, an output interface number of “IF3”, and a next hop field of “Undetermined”, respectively. The fourth entry specifies an authentication status of “Authenticated”, a virtual VRF field of “Second Enterprise”, an IP address of “13.0.0.13”, a subnet mask length of “24”, an output interface number of “IF4”, and a next hop field of “Undetermined”, respectively.

These four entries are created by the routing control module 124 during initial configuration of the network system 10c. Specifically, the routing control module 124 looks up in the interface role class table 152 shown in FIG. 14 and acquires the role classes that have been established for the interfaces 111 to 113. Next, for the interface whose role class is “Terminal Targeted for Authentication” (the first interface 111), the routing control module 124 creates an entry specifying an authentication status of “Unauthenticated”, a virtual VRF of “*”, an IP address of “the IP address established for the relevant interface (10.0.0.10)”, a subnet mask length of “the subnet mask length established for the relevant interface (24)”, an output interface number of “the interface number of the relevant interface (IF1)”, and a next hop of “Undetermined”, respectively. For the interface whose role class is “Pre-authentication” (the second interface 112), the routing control module 124 creates an entry specifying an authentication status of “*”, a virtual VRF of “*”, an IP address of “the IP address established for the relevant interface (11.0.0.11)”, a subnet mask length of “the subnet mask length established for the relevant interface (24)”, an output interface number of “the interface number of the relevant interface (IF2)”, and a next hop of “Undetermined”, respectively. For the interface whose role class is “First Enterprise” (the third interface 113), the routing control module 124 creates an entry specifying an authentication status of “Authenticated”, a virtual VRF of “First Enterprise”, an IP address of “the IP address established for the relevant interface (12.0.0.12)”, a subnet mask length of “the subnet mask length established for the relevant interface (24)”, an output interface number of “the interface number of the relevant interface (IF3)”, and a next hop of “Undetermined”, respectively. For the interface whose role class is “Second Enterprise” (the fourth interface 114), the routing control module 124 creates an entry specifying an authentication status of “Authenticated”, a virtual VRF of “Second Enterprise”, an IP address of “the IP address established for the relevant interface (13.0.0.13)”, a subnet mask length of “the subnet mask length established for the relevant interface (24)”, an output interface number of “the interface number of the relevant interface (IF4)”, and a next hop of “Undetermined”, respectively.

In the integrated VRF forwarding table 159, output interface number and next hop (routing information) searches are carried out using the Authentication Status field, the virtual VRF, the destination IP address, and the subnet mask length as search keys. In Embodiment 5, the forwarding route changes taking place before and after successful authentication are comparable to those in Embodiment 2 (see FIGS. 19, 20).

### E2. Operation During Terminal Authentication

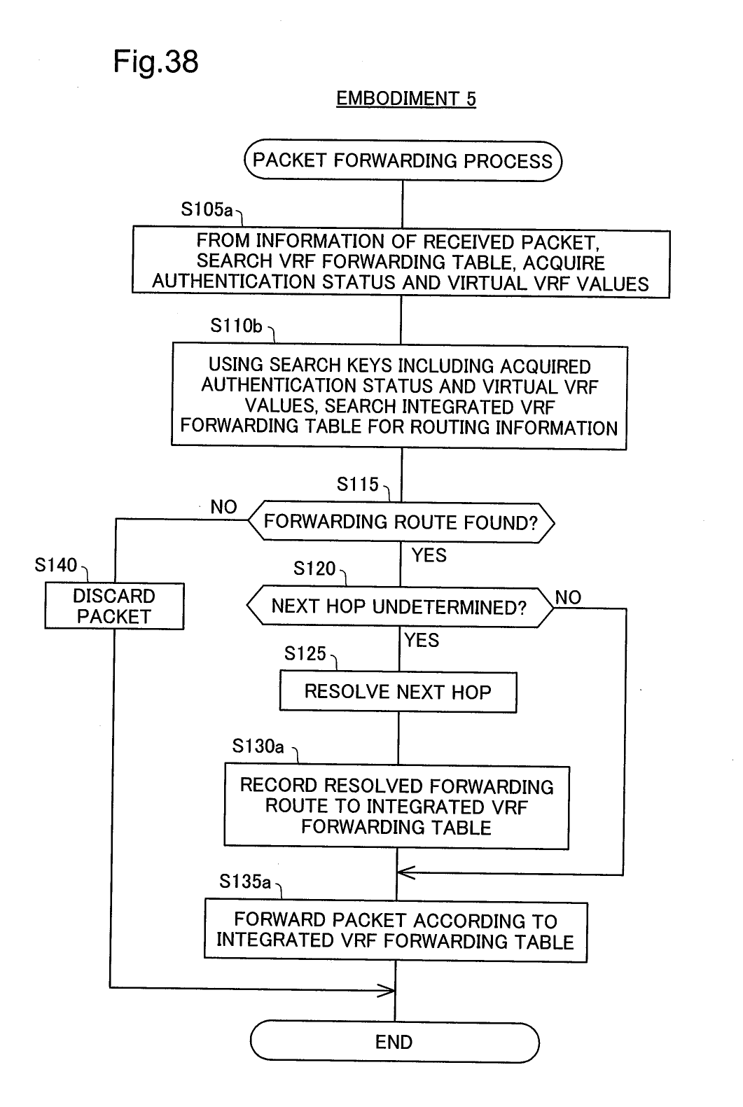

FIG. 38 is a flowchart depicting the procedure of the packet forwarding process of Embodiment 5. The discussion turns first to the packet forwarding process that takes place when authentication (authentication and quarantine) is carried out for the first terminal 11. The packet forwarding process is executed when the packet forwarding device 100b receives an authentication packet addressed to the authentication server 191. This packet forwarding process of Embodiment 5 differs from the packet forwarding process of Embodiment 2 depicted in FIG. 21 in that Step S105a is executed in place of Step S105, Step S110b is executed in place of Step S110, Step S130a is executed in place of Step S130, and Step S135a is executed in place of Step S135; the procedure is otherwise identical to Embodiment 2.

On the basis of received packet information (the receiving interface and the sender's MAC address), the VRF determination control module 128 acquires the authentication status and the virtual VRF from the VRF determination table 158 (Step S105a). For example, if authentication is being carried out for the first terminal 11, it finds the first entry shown in FIG. 36, which specifies an interface number of “IF1”, a determination class of “MAC Address” and a MAC address of “Other”, and acquires authentication status of “Unauthenticated” and a virtual VRF of “*”.

Next, using search keys (Authentication Status field, virtual VRF, destination IP address, and subnet mask length) that include the authentication status value and the virtual VRF value that were acquired in Step S105a, the VRF determination control module 128 searches the integrated VRF forwarding table 159 for a forwarding route (Step Siob).

When an authentication packet is transmitted by the first terminal 11, in Step S105a discussed above, authentication status of “Unauthenticated” and a virtual VRF of “*” are acquired, and the integrated VRF forwarding table 159 is searched using these values together with the authentication server 191 destination IP address (11.0.0.1) and the subnet mask length (32) as search keys. Consequently, the second entry is found among the entries in the integrated VRF forwarding table 159 shown in FIG. 37 (Step S115: YES).

Here, because the next hop in the first entry of the integrated VRF forwarding table 159 shown in FIG. 37 is not yet resolved, the next hop is resolved (Steps S120, S125). The routing control module 124 then adds to the integrated VRF forwarding table 159 a forwarding route entry that includes the next hop resolved in Step S125 (Step S130a).

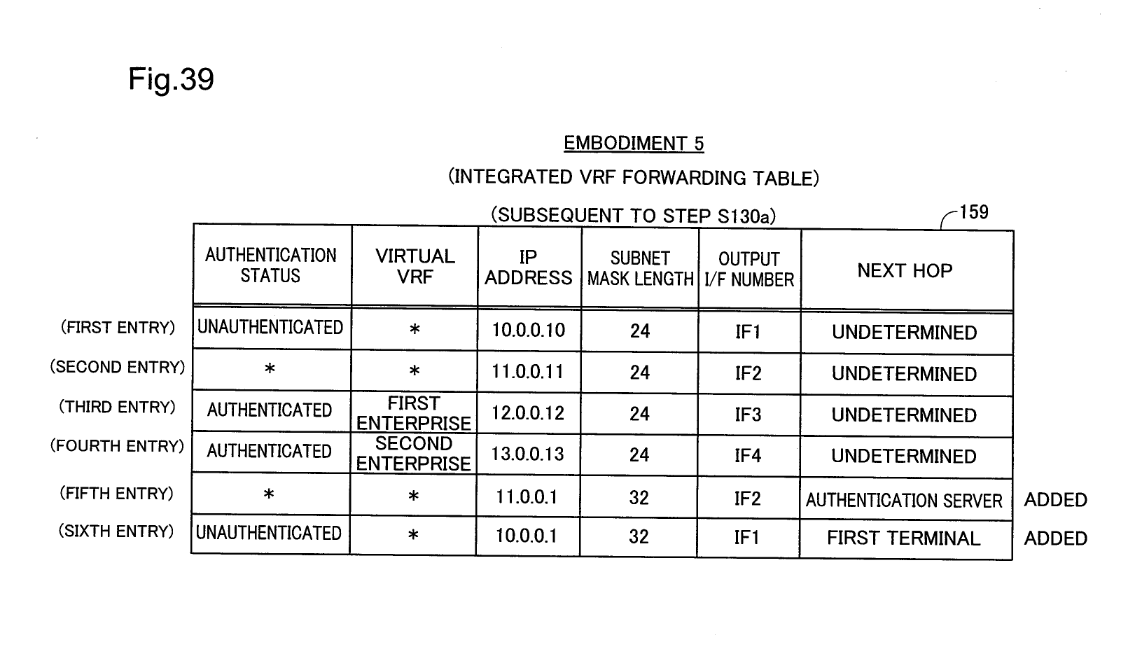

FIG. 39 is an illustration depicting the integrated VRF forwarding table 159 subsequent to exchange of packets between the first terminal 11 and the authentication server 191 prior to successful authentication. As noted, in the authentication operation, once Step S130a is executed during initial transmission of a packet from the first terminal 11 to the authentication server 191, the fifth entry shown in FIG. 39 is added. At this point in time, the sixth entry shown in FIG. 39 has not been added.

In the new entry that is added in Step S130a during initial transmission of a packet from the first terminal 11 to the authentication server 191, the values of the Authentication Status field and the Virtual VRF field are set to the values of the Authentication Status field and the Virtual VRF field specified in the entry for the interface that was used during resolution of the next hop. Accordingly, the value “*” of the Authentication Status field and the value “*” of the Virtual VRF field included in the entry for the second interface 112 (the second entry) are established in the Authentication Status field and the Virtual VRF field, respectively, in the fifth entry.

Next, the packet forwarding process module 126 forwards the received packet in accordance with the VRF forwarding table (Step S135). Thus, the packet addressed to the authentication server 191 is forwarded to the authentication server 191 in accordance with the forwarding route described in the fifth entry in FIG. 39.

The packet forwarding process is also executed during packet transmission from the authentication server 191 to the first terminal 11 prior to successful authentication, and the sixth entry shown in FIG. 39 is added to the integrated VRF forwarding table 159. Subsequently, once quarantine is carried out for the first terminal 11, and authentication and quarantine are carried out for the second terminal 12, entries that respectively describe forwarding routes to the quarantine server 192 and to the second terminal 12 are added to the integrated VRF forwarding table 159 (not shown).

As noted in Embodiment 2, once authentication (authentication and quarantine) for the first terminal 11 and the second terminal 12 are successful, the authentication process module 122 notifies the VRF determination control module 128 of the successful authentication and of network access permissions information (first terminal 11: first enterprise server 180a; second terminal 12: first enterprise server 180a and second enterprise server 180b).

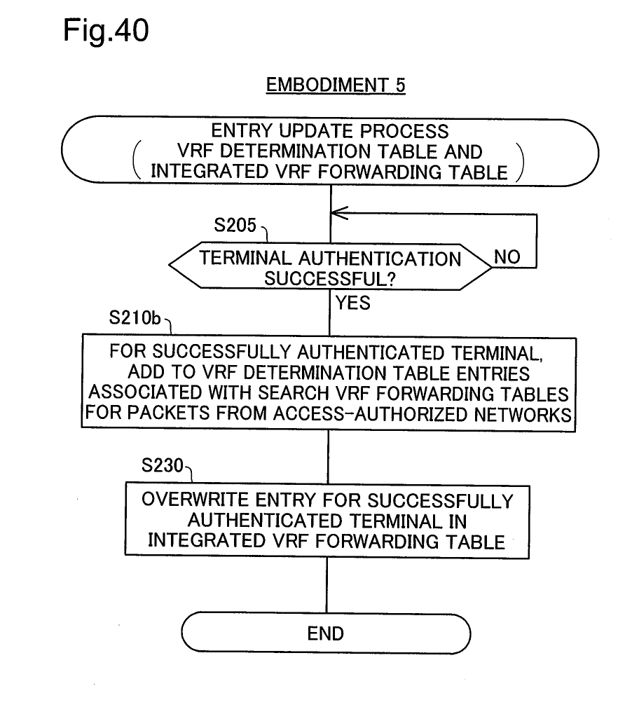

FIG. 40 is a flowchart depicting the entry update process in Embodiment 5. The update process of Embodiment 5 differs from the VRF determination table entry addition process of Embodiment 2 shown in FIG. 22 in that Step S210b is executed in place of Step S210a, and an additional Step S230 is executed; the procedure is otherwise identical to Embodiment 2.

In the event of a determination of successful authentication (Step S205: YES), the VRF determination control module 128 adds to the VRF determination table 158 an entry for the successfully authenticated terminal, that associates with it a search virtual VRF forwarding table for packets from access-permitted networks (Step S210b).

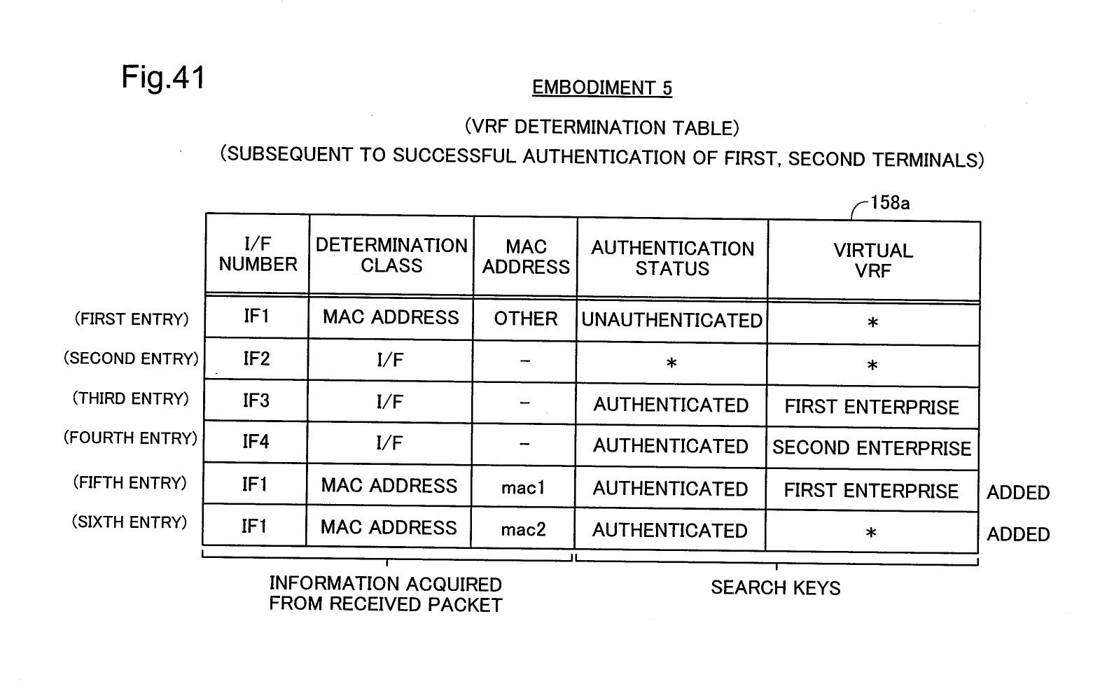

FIG. 41 is an illustration depicting the VRF determination table 158a after addition of entries for the first terminal 11 and the second terminal 12, subsequent to successful authentication of these two terminals 11, 12. The network to which the first terminal 11 has access permission is the first enterprise network 180a. The search virtual VRF forwarding table for packets from the first enterprise network 180a is the first enterprise virtual VRF forwarding table (see the third entry of the VRF determination table 158). Thus, in the event of successful authentication of the first terminal 11, the determination control module 128 adds to the VRF determination table 158 an entry (fifth entry) specifying an interface number of “IF1”, a determination class of “MAC Address”, a MAC address of “mac1”, authentication status of “Authenticated”, and a virtual VRF of “First enterprise virtual VRF forwarding table.”

The networks to which the second terminal 12 has access permissions are the first enterprise network 180a and the second enterprise network 180b. The search virtual VRF forwarding table for packets from the first enterprise network 180a is the first enterprise VRF forwarding table 154b (see the third entry of the VRF determination table 158). The search virtual VRF forwarding table for packets from the second enterprise network 180b is the second enterprise virtual VRF forwarding table 154c (see the fourth entry of the VRF determination table 158). Thus, in the event of successful authentication of the second terminal 12, the determination control module 128 adds to the VRF determination table 158 an entry (sixth entry) specifying an interface number of “IF1”, a determination class of “MAC Address”, a MAC address of “mac2”, authentication status of “Authenticated”, and a virtual VRF of “* (Both the first enterprise virtual VRF forwarding table and the second virtual VRF forwarding table are acceptable)”.

After executing Step S210b described above, the routing control module 124 updates entries for successfully authenticated terminals in the integrated VRF forwarding table 159 (Step S230). Specifically, in entries for successfully authenticated terminals, the routing control module 124 rewrites the Authentication Status field to “Authenticated”, and sets the value of the Virtual VRF field to a value indicating the search virtual VRF forwarding tables for packets from access-permitted networks.

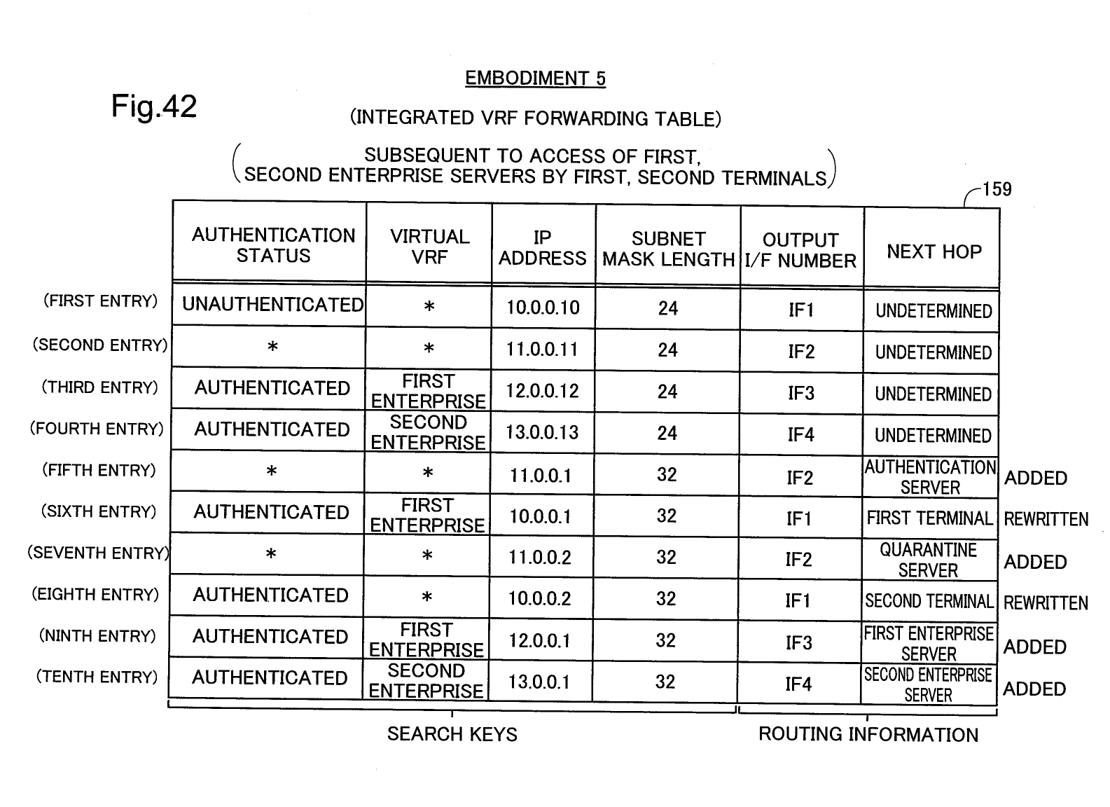

FIG. 42 is an illustration depicting the integrated VRF forwarding table 159 subsequent to successful authentication for the first terminal 11 and the second terminal 12. FIG. 42 shows the integrated VRF forwarding table 159 after access of the first enterprise 181a and the second enterprise server 181b by the first terminal 11 and the second terminal 12 subsequent to successful authentication of the two terminals 11, 12.

Prior to successful authentication, the entry for the first terminal 11 in the integrated VRF forwarding table 159 specifies an Authentication Status field value of “Unauthenticated” and a Virtual VRF field value of “*” respectively, as shown by the sixth entry of FIG. 39. In Step S230, this Authentication Status field value is rewritten from “Unauthenticated” to “Authenticated”. Because the network to which the first terminal 11 has access permission is the first enterprise network 180a, the Virtual VRF field value is rewritten from “*” to “First enterprise virtual VRF forwarding table” as shown by the sixth entry of FIG. 42.

The networks to which the second terminal 12 has access permissions are the first enterprise network 180a and the second enterprise network 180b. The search virtual VRF forwarding tables for packets from the first and second enterprise networks 180a, 180b are the first enterprise virtual VRF forwarding table 154b and the second enterprise virtual VRF forwarding table 154c. In this instance, as shown by the eighth entry of FIG. 42, the virtual VRF field value is rewritten to “* (Both the first enterprise virtual VRF forwarding table and the second virtual VRF forwarding table are acceptable”. However, because the virtual VRF value was “*” prior to successful authentication as well, rewriting does not take place. In the eighth entry, as in the sixth entry, the Authentication Status field value is rewritten from “Unauthenticated” to “Authenticated”.

In the present embodiment, in FIG. 42, the entries in which the virtual VRF field value is “*” and “First Enterprise” correspond to the first forwarding route table recited in the claims. The entries in which the virtual VRF field value is “*” and “Second Enterprise” correspond to the second forwarding route table recited in the claims.

### E3. Packet Forwarding Process After Successful Terminal Authentication

Subsequent to successful authentication, in the event of packet transmission from the first terminal 11 to the first enterprise server 181a, in Step S105a shown in FIG. 38, the authentication status “Authenticated” and the virtual VRF “First enterprise virtual VRF forwarding table” are acquired from the fifth entry of the VRF determination table 158a shown in FIG. 41. In Step S110b, using the authentication status of “Authenticated”, the virtual VRF of “First enterprise virtual VRF forwarding table”, the first enterprise server 181a IP address (12.0.0.1/32), and the subnet mask length “32” as search keys, the integrated VRF forwarding table 159 is searched for a forwarding route. In this instance, the ninth entry is hit, and packet forwarding takes place on the basis of the routing information in the ninth entry.

Here, when searching the integrated VRF forwarding table 159 for forwarding routes, the Virtual VRF value of “First enterprise virtual VRF forwarding table” included among the search keys means that the fourth and tenth entries are excluded from candidacy even before the destination IP address or subnet mask length search. The fourth and tenth entries indicate the forwarding route to the fourth interface 114 and the forwarding route to the second enterprise server 181b. Thus, routing information for these forwarding routes is dependably excluded from lookup during the search for a forwarding route for packets sent from the first terminal 11 to the first enterprise server 181a. From this example it will be appreciated that routing information for entries that differ at a minimum in their virtual VRF field values may be dependably excluded from lookup, and VRF functionality may be achieved on the part of the packet forwarding device 100b.

Subsequent to successful authentication, in the event of packet transmission from the first enterprise server 181a to the first terminal 11, in Step S105a shown in FIG. 38, authentication status of “Authenticated” and a virtual VRF of “First enterprise virtual VRF forwarding table” are acquired from the third entry of the VRF determination table 158a shown in FIG. 41. In Step S110b, using the authentication status of “Authenticated”, the virtual VRF of “First enterprise virtual VRF forwarding table”, and the first terminal 11 IP address (10.0.0.1/32) as search keys, the integrated VRF forwarding table 159 is searched for a forwarding route. In this instance, the sixth entry shown in FIG. 42 is hit, and packet forwarding takes place on the basis of the routing information in the sixth entry.

Subsequent to successful authentication, in the event of packet transmission from the second terminal 12 to the first enterprise server 181a, in Step S105a shown in FIG. 38, authentication status of “Authenticated” and a virtual VRF of “k” are acquired from the sixth entry of the VRF determination table 158a shown in FIG. 41. In Step S110b, using the authentication status of “Authenticated”, the virtual VRF of “*”, and the first enterprise server 181a IP address (12.0.0.1/32) as search keys, the integrated VRF forwarding table 159 is searched for a forwarding route. In this instance, because the value of the virtual VRF field is “* (Both the first enterprise virtual VRF forwarding table and the second virtual VRF forwarding table are acceptable”, the ninth entry shown in FIG. 42 is hit, and packet forwarding takes place on the basis of the routing information in the ninth entry.

Subsequent to successful authentication, in the event of packet transmission from the first enterprise server 181a to the second terminal 12, in Step S105a shown in FIG. 38, authentication status of “Authenticated” and a virtual VRF of “First enterprise virtual VRF forwarding table” are acquired from the third entry of the VRF determination table 158a shown in FIG. 41. In Step S110b, using the authentication status of “Authenticated”, the virtual VRF of “First enterprise virtual VRF forwarding table”, and the second terminal 12 IP address (10.0.0.2/32) as search keys, the integrated VRF forwarding table 159 is searched for a forwarding route. In this instance, because the value of the virtual VRF field in the eighth entry of the integrated VRF forwarding table 159 shown in FIG. 42 is “* (Both the first enterprise virtual VRF forwarding table and the second virtual VRF forwarding table are acceptable”, the eighth entry is hit. Consequently, packet forwarding takes place on the basis of the routing information in this eighth entry.

Subsequent to successful authentication, in the event of packet transmission from the second terminal 12 to the second enterprise server 181b, in Step S105a shown in FIG. 38, authentication status of “Authenticated” and a virtual VRF of “*” are acquired from the sixth entry of the VRF determination table 158a shown in FIG. 41. In Step S110b, using the authentication status of “Authenticated”, the virtual VRF of “*”, and the second enterprise server 181b IP address (13.0.0.1/32) as search keys, the integrated VRF forwarding table 159 is searched for a forwarding route. In this instance, because the value of the virtual VRF field is “* (Both the first enterprise virtual VRF forwarding table and the second virtual VRF forwarding table are acceptable”, the tenth entry shown in FIG. 42 is hit, and packet forwarding takes place on the basis of the routing information in this tenth entry.

Subsequent to successful authentication, in the event of packet transmission from the second enterprise server 181b to the second terminal 12, in Step S105a shown in FIG. 38, authentication status of “Authenticated” and a virtual VRF of “Second enterprise virtual VRF forwarding table” are acquired from the fourth entry of the VRF determination table 158a shown in FIG. 41. In Step S110b, using the authentication status of “Authenticated”, the virtual VRF of “Second enterprise virtual VRF forwarding table”, and the second terminal 12 IP address (10.0.0.2/32) as search keys, the integrated VRF forwarding table 159 is searched for a forwarding route. In this instance, because the value of the virtual VRF field in the eighth entry of the integrated VRF forwarding table 159 shown in FIG. 42 is “* (Both the first enterprise virtual VRF forwarding table and the second virtual VRF forwarding table are acceptable”, the eighth entry is hit. Consequently, packet forwarding takes place on the basis of the routing information in this eighth entry.

Subsequent to successful authentication, in the event of packet transmission from the first terminal 11 to the authentication server 191, in Step S105a shown in FIG. 38, authentication status of “Authenticated” and a virtual VRF of “First enterprise virtual VRF forwarding table” are acquired from the fifth entry of the VRF determination table 158a shown in FIG. 41. In Step S110b, using the authentication status of “Authenticated”, the virtual VRF of “First enterprise virtual VRF forwarding table”, and the authentication server 191 IP address (11.0.0.1/32) as search keys, the integrated VRF forwarding table 159 is searched for a forwarding route. In this instance, in the fifth entry of the integrated VRF forwarding table 159 shown in FIG. 42, the value of the Authentication Status field is “* (Both pre- and post-authentication statuses are acceptable” and the value of the virtual VRF field is “* (Both the first enterprise virtual VRF forwarding table and the second virtual VRF forwarding table are acceptable”. Consequently, the fifth entry is hit, and packet forwarding takes place on the basis of the routing information in this fifth entry.

Subsequent to successful authentication, in the event of packet transmission from the authentication server 191 to the first terminal 11, in Step S105a shown in FIG. 38, authentication status of “*” and a virtual VRF of “*” are acquired from the second entry of the VRF determination table 158a shown in FIG. 41. In Step S110b, using the authentication status of “*”, the virtual VRF of “*”, and the first terminal 11 IP address (10.0.0.1/32) as search keys, the integrated VRF forwarding table 159 is searched for a forwarding route. In this instance, the sixth entry shown in FIG. 42 is hit, and packet forwarding takes place on the basis of the routing information in the sixth entry.

The discussion now turns to an instance in which the first terminal 11 attempts to transmit a packet to the second enterprise server 181b in the second enterprise network 180 to which it does not have access permission. In this case, authentication status of “Authenticated” and a virtual VRF of “First enterprise virtual VRF forwarding table” are acquired from the third entry of the VRF determination table 158a shown in FIG. 41. In Step S110b, using the authentication status of “Authenticated”, the virtual VRF of “First enterprise virtual VRF forwarding table”, and the second enterprise server 181b IP address (13.0.0.1/32) as search keys, the integrated VRF forwarding table 159 is searched for a forwarding route. In this instance, in the tenth entry indicating the forwarding route to the second enterprise server 181b shown in FIG. 42, only the “Second enterprise virtual VRF forwarding table” is specified as the value of the Virtual VRF field. Consequently, the tenth entry is not hit, and the packet transmitted from the first terminal 11 is discarded without forwarding.

### E4. Entry Deletion Process

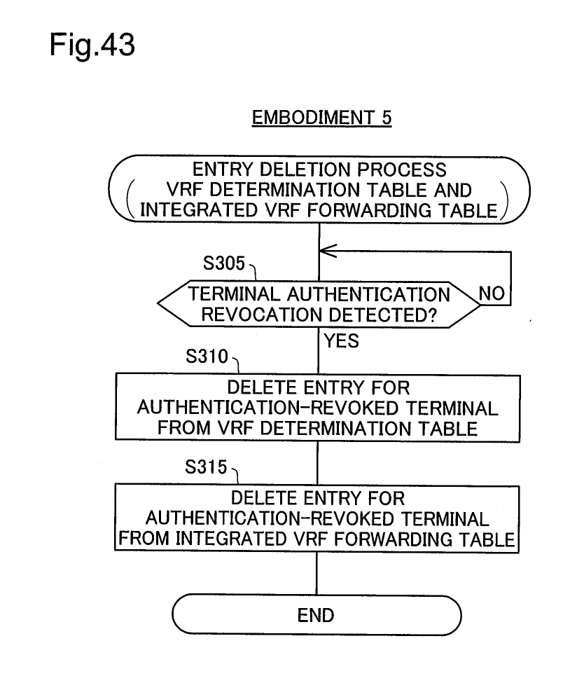

FIG. 43 is a flowchart depicting the procedure of the entry deletion process of Embodiment 5. The entry deletion process of Embodiment 5 differs from the VRF determination table 158 entry deletion process of Embodiment 1 depicted in FIG. 12 in that Step S315 is carried out, but the procedure is otherwise identical to Embodiment 1.

After the entry for a terminal whose authentication was revoked is deleted from the VRF determination table 158a in Step S310 shown in FIG. 43, the routing control module 124 deletes the entry for the authentication-revoked terminal from the integrated VRF forwarding table 159. Specifically, if authentication was revoked for the second terminal 12, the eighth entry shown in FIG. 42 is deleted. By deleting the entry for an authentication-revoked terminal from the integrated VRF forwarding table 159 as well as from the VRF determination table 158a in this way, it is possible to avoid situations in which the forwarding route to the authentication-revoked terminal is looked up during a search for a forwarding route to another device, thus enhancing security.

The network system 10c of Embodiment 5 described above affords effects comparable to those of the network system 10a of Embodiment 2. Additionally, by establishing an entry for each forwarding route in the integrated VRF forwarding table 159, duplicate descriptions of the same forwarding route in multiple tables can be avoided, and the memory capacity of the packet forwarding device 100a can be smaller.

Additionally, when successful authentication of a terminal takes place, an entry associating the terminal with a search virtual VRF forwarding table for packets from networks to which it has access permission is added to the VRF determination table 158a. Thus, during the search for a forwarding route for packets from the successfully authenticated terminal, it is possible to avoid situations where the forwarding route for which the value of the Virtual VRF field is not the “Search virtual VRF forwarding table” (i.e. a forwarding route to a device on a network to which the terminal does not have access permission), thereby providing stronger security.

Also, in the event of successful authentication of a terminal, the entry for the terminal in the integrated VRF forwarding table 159 is updated to associate it with a search virtual VRF forwarding table for packets from a network or networks to which it has access permission. Thus, only packets from a server that belongs to a network associated with the search virtual VRF forwarding table can be forwarded to the successfully authenticated terminal; packets addressed to the successfully authenticated terminal from servers belonging to other networks are discarded. This affords stronger security of the network system 10c.

### F. Modified Examples

Of the constituent elements set forth in the preceding embodiments, elements other than those expressly claimed in independent claims are additional elements and may be dispensed with as appropriate. The invention is not limited by the embodiments herein and may be reduced to practice in various other modes such as the following modifications, while remaining within the spirit of the invention.

### F1. Modified Example 1

In Embodiment 5, the VRF determination table 158a and the integrated VRF forwarding table 159 are provided with a “Virtual VRF” field for the purpose of indicating a search virtual VRF forwarding table, but this arrangement could be replaced by fields that describe flags associated with virtual VRF forwarding tables (i.e. a flag indicating whether to use or not use the table). With this feature, by setting respective flags that correspond to search virtual VRF forwarding tables to the ON state (the “Use” setting), any of the virtual VRF forwarding tables can be specified as search virtual VRF forwarding tables.

Also, in instances where lookup of multiple virtual VRF forwarding tables during forwarding route searches is allowed, fields that describe flags corresponding to individual combinations (groups) of tables in which lookup is allowed may be provided beforehand, and the search virtual VRF forwarding tables can be indicated by the values of these fields (i.e. ON/OFF status of the flags). According to this feature, there may be provided a table (combination table) that describes which flags (fields) are associated with combinations of tables, and the search virtual VRF forwarding tables can be indicated by setting to ON the flags of fields obtained by lookup in this combination table.

With this feature, the number of entries can be reduced in the VRF determination table 158a and the integrated VRF forwarding table 159, and the amount of information contained in individual entries can be smaller as compared with an arrangement in which individual virtual VRF forwarding tables are provided with corresponding flags, so the capacity of the memory provided to the packet forwarding device can be smaller.

### F2. Modified Example 2

In the preceding embodiments, both an authentication process and a quarantine process are executed by way of the terminal authentication operation, but the operation may involve either an authentication process or a quarantine process only. That is, generally, the network system of the invention may employ a configuration provided with a server that executes at least an authentication process or a quarantine process.

### F3. Modified Example 3

While the information used to identify the packet sender was either the MAC address (Embodiment 1) or the IP address (Embodiment 3), the invention is not limited to these arrangements. For example, the packet sender may be identified using both the MAC address and the IP address. This feature affords more reliable identification of the packet sender, thus reducing the risk of unauthorized access through fraudulent acts such as IP address spoofing or MAC address spoofing. For arrangements employing IPX (Internetwork Packet eXchange) packets instead of IP packets as Layer 3 packets, the packet sender may be identified using the IPX address in place of the IP address.

### F4. Modified Example 4

In the preceding embodiments, each terminal 11, 12 was assigned an IP address in advance, but IP addresses could be assigned dynamically by DHCP instead. Such an arrangement affords the same effects as the network systems taught in the preceding embodiments. In the embodiments, because the network to which the terminals belong can be configured as a single VLAN, a single DHCP server is sufficient, and because no special functionality is added to the DHCP server, the cost of building the network system 10, 10a-10c is lower as compared to an arrangement where multiple DHCP servers are provided and the DHCP servers have added special functionality.

### F5. Modified Example 5

In the preceding embodiments, the value specified in the “Next Hop” field of the forwarding tables was the MAC address of the specific sender of the packet, but the invention is not limited to this arrangement. Specifically, an ARP table may be provided separately from the forwarding tables, and the “Next Hop” field may specify a destination IP address which serves as a key during lookup in the ARP table. According to this arrangement, in Step S125 of the packet forwarding process, the packet forwarding process module 126, using the destination IP address as the key, searches the ARP table and acquires the MAC address of the packet sender.

### F6. Modified Example 6

In the preceding embodiments, the values of the forwarding tables in the initial state are generated by the routing control module 124 or the VRF determination module 182 on the basis of the interface role class table 152, but the invention is not limited to this arrangement. In an alternative arrangement, no interface role class table 152 is provided, and the system administrator makes the settings manually. Such an arrangement affords the same effects as the network systems taught in the preceding embodiments. Additionally, due to the lack of the interface role class table 152, the capacity of the memory provided to the packet forwarding device 100, 100a, 100b can be smaller, and the cost to build the network system 10, 10a-10c can be kept to a minimum.

### F7. Modified Example 7

In the preceding embodiments, the IP addresses were IPv4 addresses, but IPv6 addresses could be employed instead. This arrangement affords the same effects as the network systems taught in the preceding embodiments. Additionally, because the network to which the terminals belong can be configured as a single VLAN, a single RA (Router Advertisement) from the packet forwarding device 100 suffices, thereby avoiding generation of two IP address for the same terminal.

### F8. Modified Example 8

In Embodiments 1 to 4, the VRF determination table 158 contains an entry provided for use by any terminal prior to authentication (e.g. the first entry shown in FIG. 3); alternatively, entries in which the VRF Forwarding Table Class field specifies “Terminal VRF” can be created in advance for terminals that may join the user network 170, and the VRF Forwarding Table Class field contained in the entry for a successfully authenticated terminal subsequently updated after successful authentication.

### F9. Modified Example 9

In Embodiments 1 to 4, the VRF determination table 158 is employed in order to select a search VRF forwarding table to use for packets transmitted from the terminals 11, 12, but the selection could be made without using a VRF determination table. As a specific example, in place of Step S105 of Embodiment 1, on the basis of the sender's IP address of a received packet, the packet forwarding process module 126 may determine whether a packet was transmitted from a terminal, and if the packet was transmitted from a terminal, then query the authentication process module 122 as to whether the terminal was successfully authenticated. In the event that the packet forwarding process module 126 is notified of successful authentication, it selects the post-authentication VRF forwarding table as the search VRF forwarding table, or in the event that the packet forwarding process module 126 is notified that successful authentication has not yet taken place, it selects the terminal VRF forwarding table as the search VRF forwarding table. Such an arrangement affords the same effects as the network systems 10, 10a-10c taught in the preceding embodiments.

What is claimed is:

1. A network system comprising:
a first network;
an authentication server configured to execute an authentication process when a terminal apparatus joins the first network;
a second network to which the authentication server is connected;
a third network to which the terminal apparatus and the authentication server are not connected; and
a packet forwarding apparatus being connected to the first network, the second network, and the third network, and forwarding packets,
wherein the packet forwarding apparatus includes:
a forwarding route table storage storing a first forwarding route table that contains packet routing information to a prescribed device connected to the second network, and a second forwarding route table that contains packet routing information to a prescribed device connected to the second network and packet routing information to a prescribed device connected to the third network; and
a forwarding route table selector that, prior to determination of successful authentication for the terminal apparatus by the authentication server, selects the first forwarding route table as a search forwarding route table that is used for searching for a packet routing information applied to packets from the terminal apparatus, and that upon receipt of determination of successful authentication for the terminal apparatus by the authentication server, selects the second forwarding route table as the search forwarding route table.

2. The network system in accordance with claim 1, further comprising:
a search forwarding route table selection table associating sender identifiers that identify the packet sender with the search forwarding route tables; and
a table updater updating the search forwarding route table selection table;
wherein the forwarding route table selector selects the forwarding route table for a received packet according to the search forwarding route table selection table;
the search forwarding route table selection table preliminary associates the first forwarding route table with the sender identifier of the terminal apparatus prior to determination of successful authentication of the terminal apparatus by the authentication server; and
upon receipt of determination of successful authentication of the terminal apparatus by the authentication server, the table updater updates the search forwarding route table selection table so as to associate the second forwarding route table with the sender identifier of the terminal apparatus.

3. The network system in accordance with claim 1, wherein
the network system includes a plurality of the third networks;
the forwarding route table storage stores a plurality of the second forwarding route tables that include packet routing information to prescribed devices connected to mutually different third networks and packet routing information to a prescribed device connected to the second network;
the authentication server notifies the forwarding route table selector of an outcome of the authentication process and of information relating to at least one authorized network that authorized for connection and included among the plurality of the third networks; and
the forwarding route table selector, prior to determination of successful authentication of the terminal apparatus by the authentication server, selects the first forwarding route table as the search forwarding route table applied to packets from the terminal apparatus, and upon receipt of determination of successful authentication of the terminal apparatus by the authentication server, selects the second forwarding route table that contains packet routing information to a prescribed device connected to the at least one authorized network from among the plurality of second forwarding route tables, as the search forwarding route table applied to packets from the terminal apparatus.

4. The network system in accordance with claim 2, wherein
the packets are IP packets; and
the sender identifier is at least one of the MAC address and the IP address.

5. The network system in accordance with claim 1, wherein
when an authentication for the terminal apparatus connected to first network is revoked by the authentication server, the forwarding route table selector switches back from the second forwarding route table to the first forwarding route table as the search forwarding route table applied to packets from the terminal apparatus.

6. The network system in accordance with claim 3, further comprising:
a forwarding route selector selecting a packet forwarding route; and
a forwarding route table updater updating forwarding route tables stored in the forwarding route table storage; wherein
in addition to the first forwarding route table and the second forwarding route table, the forwarding route table storage stores a third forwarding route table that includes packet routing information to a prescribed device connected to the first network;
the forwarding route table selector selects the second forwarding route table as the search forwarding route table for forwarding packets from each third network to the first network and the second network, and selects the third forwarding route table as the search forwarding route table for forwarding packets from the second network to the first network; and
the forwarding route table updater, during packet forwarding from the authentication server to the terminal apparatus in the authentication process, adds to the third forwarding route table terminal apparatus routing information representing packet routing information to the terminal apparatus that was selected by the forwarding route selector, and upon receipt of determination of successful authentication of the terminal apparatus by the authentication server, acquires the terminal apparatus routing information from the third forwarding route table and copies the terminal apparatus routing information to the second forwarding route table that is included among the plurality of second forwarding route tables and that contains packet routing information to a prescribed device connected to the at least one authorized network.

7. The network system in accordance with claim 6, wherein
when the authentication of the terminal apparatus connected to the first network is revoked by the authentication server, the forwarding route table updater deletes the terminal apparatus routing information from the second forwarding routing table.

8. The network system in accordance with claim 2, further comprising:
a forwarding route selector selecting packet forwarding routes;
wherein the first forwarding route table and the second forwarding route table are constituted as an integrated forwarding route table;
the search forwarding route table selection table associating the sender identifier with the outcome of the authentication process and with a search forwarding route table identifier indicating the search forwarding route table;
the integrated forwarding route table associating routing information contained in the first forwarding route table and in the second forwarding route table with the outcome of the authentication process and with the search forwarding route table identifier;
the search forwarding route table selection table, preliminary associates the sender identifier of the terminal apparatus with information indicating that the authentication process has not successfully taken place, and with an identifier representing the first forwarding route table as the search forwarding route table identifier prior to determination of successful authentication of the terminal apparatus by the authentication server;
the authentication server notifies the table updater at least the outcome of the authentication process;
the table updater, upon being notified of successful authentication of the terminal apparatus by the authentication server, updates the search forwarding route table selection table so as to associate the sender identifier of the terminal apparatus with information indicating that the authentication process was successful and with an identifier representing the second forwarding table as the search forwarding route table identifier;
for a received packet, the forwarding route table selector looks up the search forwarding route table selection table according to the sender identifier of the packet, and acquires the outcome of the authentication process and the search forwarding route table identifier; and
the forwarding route selector looks up the integrated forwarding route table, and selects a forwarding route for the packet according to the outcome of the authentication process and the search forwarding route table identifier acquired by the forwarding route table selector.

9. The network system in accordance with claim 8, wherein
the network system includes a plurality of the third networks;
the forwarding route table storage stores a plurality of the second forwarding route tables that include packet routing information to prescribed devices connected to mutually different third networks, and packet routing information to a prescribed device connected to the second network;
the authentication server notifies the table updater of the outcome of the authentication process and of an information relating at least one authorized network authorized for connection and included among the plurality of the third networks; and
upon being notified of successful authentication of the terminal apparatus and the information relating to the at least one authorized network by the authentication server, the table updater updates the search forwarding route table selection table so as to associate the sender identifier of the terminal apparatus with information indicating that the authentication process was successful, and, as the search forwarding route identifier, with the identifier identifying the second forwarding route table that contains packet routing information to a prescribed device connected to the at least one authorized network and that is selected from among the plurality of second forwarding route tables.

10. The network system in accordance with claim 9, further comprising:
a combination table associating combinations of the second forwarding route tables that contain packet routing information to prescribed devices connected to the at least one authorized network with combination identifiers that identify the combinations,
wherein the search forwarding route table selection table and the integrated forwarding route table use the combination identifiers as the search forwarding route table identifiers for the second forwarding route tables; and
upon being notified of successful authentication of the terminal apparatus and the information relating to the at least one authorized network by the authentication server, the table updater acquires from the combination table an authorized combination identifier that is a combination identifier of a combination of the second forwarding route tables containing packet routing information to prescribed devices connected to the at least one authorized network, and updates the search forwarding route table selection table so as to associate the sender identifier of the terminal apparatus with information indicating that the authentication process was successful, and with the authorized combination identifier.

11. A packet forwarding apparatus configured to forward packets and to be connected to a first network, a second network to which an authentication server executing an authentication process when a terminal apparatus joins the first network is connected, and a third network to which the terminal apparatus and the authentication server are not connected, comprising:
a forwarding route table storage storing a first forwarding route table that contains packet routing information to a prescribed device connected to the second network, and a second forwarding route table that contains packet routing information to a prescribed device connected to the second network and packet routing information to a prescribed device connected to the third network; and
a forwarding route table selector that, prior to determination of successful authentication for the terminal apparatus by the authentication server, selects the first forwarding route table as a search forwarding route table used for searching for a packet routing information applied to packets from the terminal apparatus, and that upon receipt of determination of successful authentication for the terminal apparatus by the authentication server, selects the second forwarding route table as the search forwarding route table.

12. A method of forwarding packets in a packet forwarding apparatus, the packet forwarding apparatus configured to forward packets and to be connected to a first network, a second network to which an authentication server executing an authentication process when a terminal apparatus joins the first network is connected, and a third network to which the terminal apparatus and the authentication server are not connected,
the method comprising:
(a) storing in the packet forwarding apparatus a first forwarding route table that contains packet routing information to a prescribed device connected to the second network, and a second forwarding route table that contains packet routing information to a prescribed device connected to the second network and packet routing information to a prescribed device connected to the third network; and
(b) prior to determination of successful authentication for the terminal apparatus by the authentication server, selecting the first forwarding route table as a search forwarding route table that is used for searching for a packet routing information applied to packets from the terminal apparatus, and upon receipt of determination of successful authentication for the terminal apparatus by the authentication server, selecting the second forwarding route table as the search forwarding route table.
